(19) United States
(12) Patent Application Publication
(10) Pub. No.: US 2025/0041884 A1
(43) Pub. Date: Feb. 6, 2025

(54) PERSONAL HYGIENE WASHING DEVICES, SYSTEMS, METHODS AND KITS

(71) Applicant: MAKE THE WORLD LESS CRAPPY, INC., Chicago, IL (US)

(72) Inventors: Barthelemy Constantin Edgard MENAYAS, Chicago, IL (US); Luke Christine Michael MONTGOMERY, Chicago, IL (US); Oleksii TARELIN, Chicago, IL (US); Steven Richard REMY, Chicago, IL (US)

(73) Assignee: MAKE THE WORLD LESS CRAPPY, INC., Chicago, IL (US)

(21) Appl. No.: 18/717,663

(22) PCT Filed: Dec. 12, 2022
(86) PCT No.: PCT/US22/81337

§ 371 Date: Jun. 7, 2024

Related U.S. Application Data
(60) Provisional application No. 63/265,296, filed on Dec. 13, 2021.

(51) Int. Cl. B05B 7/04; E03D 9/08

(52) U.S. Cl. CPC B05B 7/0408; E03D 9/085

(57) ABSTRACT

Disclosed are systems, devices, methods and kits, for adapting a standard toilet that works with an existing water supply and/or plumbing to provide the functionality of a bidet. Additionally, disclosed are solution delivery systems operable to deliver a soap-free, zero residue cleaning agent. Also disclosed are fluid delivery devices that provides improved control of a stream of fluid from a bidet system that targets the anatomical area of interest.

### CROSS-REFERENCE

This application claims the benefit of U.S. Provisional Application No. 63/265,296, filed Dec. 13, 2021, entitled PERSONAL HYGIENE WASHING DEVICES, SYSTEMS, METHODS AND KITS which application is incorporated herein in its entirety by reference.

This application is related to the following co-pending patent application: application Ser. No. 17/403,323 filed Aug. 16, 2021, which is incorporated herein in its entirely by reference.

### BACKGROUND

Field: Sanitary washing apparatuses, systems, methods, and kits for the anal and genitalia anatomy.

Maintaining cleanliness of the anal and genital areas is a problem as old as time. The bidet dates back to use in France in the 1600s and provided a wash basin which was used as a second step to the use of a chamber pot. Standalone bidets are still popular in Italy, Portugal, Japan, Argentina and Venezuela.

During the U.S. Civil War, President Lincoln and his Cabinet used then groundbreaking Gayetty's Medicated Paper in the water closet (i.e., when using the toilet). The next noteworthy improvement occurred when Wheeler invented perforated paper on a roll (U.S. Pat. No. 465,588) in 1891. Starting in the 1880s flush toilets (known as water closets) were also introduced in the homes of the wealthy and hotels. Still, as late as 1940 nearly half of the houses in the US lacked hot piped water, a bathtub or shower, or a flush toilet.

As indoor plumbing became increasingly common, more and more homes installed toilets. While bidets are more hygienic than standard toilet paper, the widespread adoption of the bidet has lagged. The lag in the adoption of bidets in the US is likely influenced by the fact that bidets are typically stand-alone devices not easily retrofitted into many homes and facilities. In order to overcome the retrofitting issue, bidet attachments (e.g., bidet toilet seat adapters) have been developed for use with a standard toilet. However, the bidet adapters do not deliver the same level of cleanliness that a standalone bidet delivers. Neither the adaptive or stand-alone bidet provide a targeted spray that focuses fluid application to a specific area of interest, or a fluid that contains a cleaning agent.

As the world comes to terms with the ubiquitous nature of germ transmission following, for example, the COVID-19 pandemic, awareness of the importance of hygiene has increased. Additionally, as younger generations desire to reduce negative impacts on the environment caused by various activities of modern life, awareness of the impact toilet paper has on deforestation and the amount of energy and water required to make a single roll of toilet paper has become a pressing environmental issue for many.

What is needed are systems, devices, methods, and kits for adapting a standard toilet that works with the existing water supply to provide the functionality of a bidet that also has the hygienic features of a bidet. Additionally, what is needed are solutions that provide a soap-free, zero residue cleaning agent. Also what is needed is a way to provide an improved fluid spray that accurately targets the anatomical area of interest which is ergonomically optimized for use by both women and men either from an anterior (front) or ventral (back) position. Also what is needed is a pH balanced solution and a way to deliver the PH balanced solution. What is needed are also systems that facilitate changing between a soft flow and a hard flow.

### SUMMARY

Disclosed are systems, devices, methods and kits, for adapting a standard toilet that works with an existing water supply and/or plumbing to provide the functionality of a bidet. The systems, devices, methods and kits provide for a 2 stage dilution of fluid prior to applying the fluid to a user. Additionally, a solution delivery system is disclosed that is configured to provide a soap-free, zero residue cleaning agent. The devices and methods provide for the use of a concentrate that is diluted and delivery is regulated by injection of air and concentrate. A wand valve provides a constant flow via the variably use of one or two apertures of different sizes on the distal end. The apertures can be triangular to provide a straight stream. Also disclosed is a fluid delivery device that provides improved control of a stream of fluid from a bidet system that targets the anatomical area of interest (e.g. target area) including the genitalia, perineum, and anus. Also disclosed are systems and devices that provide an improved fluid spray that accurately targets the anatomical area of interest which is ergonomically optimized for use by both women and men either from an anterior (front) or ventral (back) position and which can change between a soft flow and a hard flow. Also disclosed are is a pH balanced solutions and a way to deliver the PH balanced solutions.

During a first mixing step, a telescoping flushing needle is used to pierce the pod containing the concentrate. The flushing needle is operable to project upward. Air is minimized to reduce or eliminate the presence of foam. A pressure/vent hole allows for auto-filling. The pod is an antibacterial acid mix with pH balancing formulation. Additionally the formulation can include one or more pharmaceuticals for topical delivery. The pod is designed to dissolve immediately.

The delivery wand is ergonomically configured to optimize fluid delivery. A retractable hose is provided that retracts the wand into a storage position when the wand is not is in use. The retraction of the wand is provides a smooth return. An ergonomic no-hose connector hub is also provided. Retraction of the wand is achieved by a reel safety shut off valve. The reel safety shut off valve turns off the water so that pressure is not applied to the wand during storage. A push-push mechanism is provided that allows a first push of a first pressure is used to insert the pod, and a second push The form factor is designed so that the Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
DE 2510939 A1 dated Sep. 23, 1976 to Benthin;
JP 2011252311 A dated Dec. 15, 2011 to Kawamura et al.;
KR 200338303 Y1 dated Jan. 16, 2004;
U.S. Pat. No. 465,588 A dated 1891 Dec. 22 to Wheeler;
U.S. Pat. No. 4,000,742 A dated Jan. 4, 1977 to Digicomo;
U.S. Pat. No. 4,205,402 A dated Jun. 3, 1980 to Miller;
U.S. Pat. No. 4,441,219 A dated Apr. 10, 1984 to Epstein;
U.S. Pat. No. 4,807,311 A dated Feb. 28, 1989 to Ingels;
U.S. Pat. No. 5,685,028 A dated Nov. 11, 1997 to Miller et al.;
U.S. Pat. No. 5,987,659 A dated Nov. 23, 1999 to Cannizzaro;
U.S. Pat. No. 6,035,458 A dated Mar. 14, 2000 to Tarzia;
U.S. Pat. No. 6,397,406 B1 dated Jun. 4, 2002 to Moshkovich;
U.S. Pat. No. 6,671,892 B1 dated Jan. 6, 2004 to Plyant;
U.S. Pat. No. 6,941,590 B2 dated Sep. 13, 2005 to Lim;
U.S. Pat. No. 7,065,802 B2 dated Jun. 27, 2006 to Jung;
U.S. Pat. No. 7,316,038 B2 dated Jan. 8, 2008 to Egeresi;
US 2008/0134423 A1 dated Jun. 12, 2008 to Ding;
U.S. Pat. No. 7,690,392 B1 dated Apr. 6, 2010 to Sarkiss;
U.S. Pat. No. 8,505,126 B2 dated Aug. 13, 2013 to Morotomi et al.;
U.S. Pat. No. 9,074,361 B2 dated Jul. 7, 2015 to Mochita et al.;
U.S. Pat. No. 10,233,626 B2 dated Mar. 19, 2019 to Otowa et al.;
U.S. Pat. No. 10,557,257 B1 dated Feb. 11, 2020 to Al Sabah et al.;
U.S. Pat. No. 10,604,923 B2 dated Mar. 31, 2020 to Lee et al.;
U.S. Pat. No. 10,619,336 B2 dated Apr. 14, 2020 to Jung et al.;
US 2002/0042946 A1 dated Apr. 18, 2002 to Jeon;
US 2007/0044223 A1 dated Mar. 1, 2007 to Mengistu;
US 2007/0256226 A1 dated Nov. 8, 2007 to Pinizzotto;
US 2008/0201837 A1 dated Aug. 28, 2008 to Oh;
US 2009/0053010 A1 dated Feb. 26, 2009 to Schnier;
US 2015/0313424 A1 dated Nov. 5, 2015 to Lara;
WO 1991/003974 A1 dated Apr. 4, 1991 to Constantinos; and
WO 2020/043498 A1 dated Mar. 5, 2020 to Boubsi.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-L illustrate a system for personal hygiene washing devices and alternative use environments;

FIGS. 2A-K illustrate an exemplar fluid applicator of a personal hygiene washing device or system;

FIGS. 3A-Z illustrate a mixing tank;

FIGS. 4A-O illustrate a base; and

FIGS. 5A-F illustrate a hub.

### DETAILED DESCRIPTION

### I. Systems

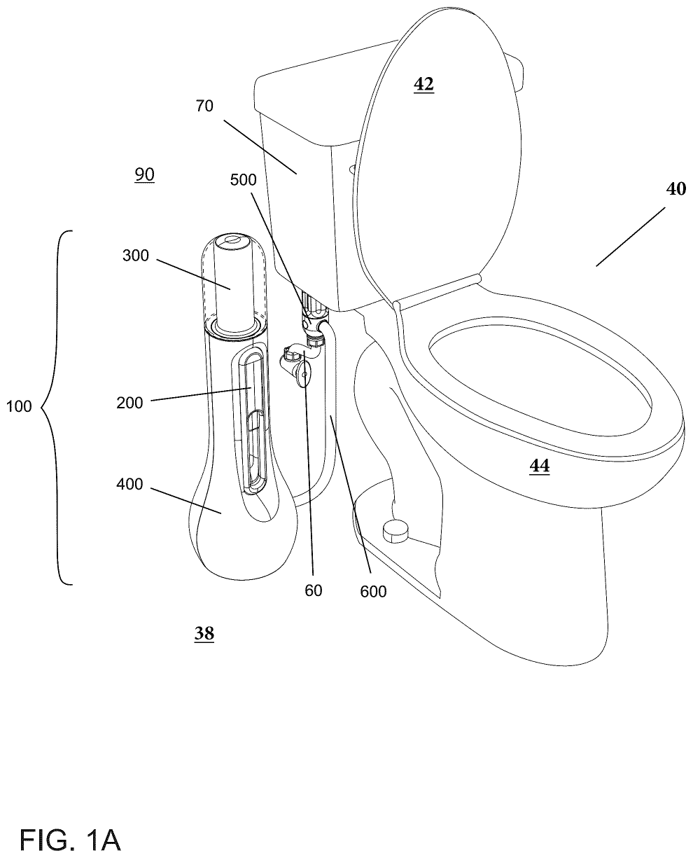

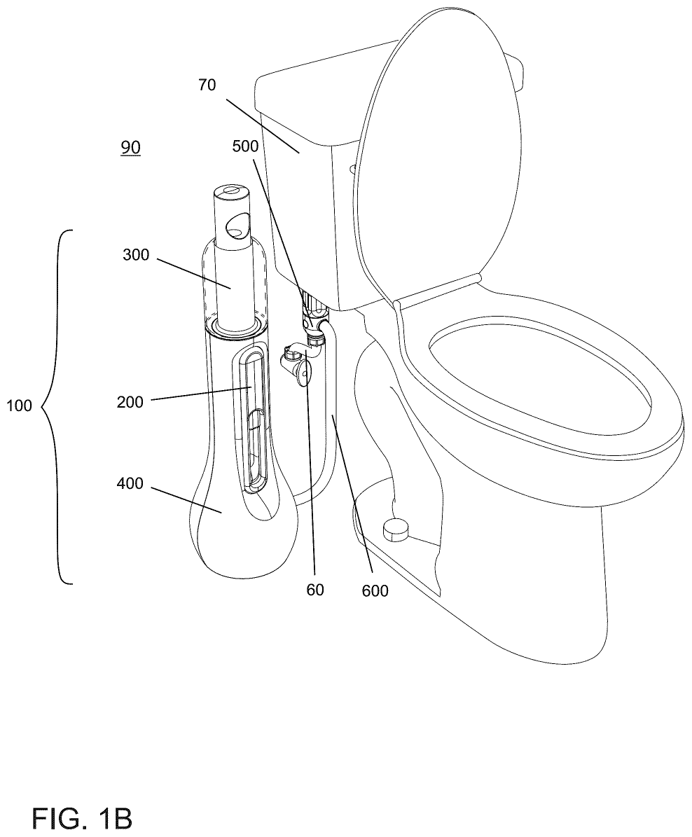

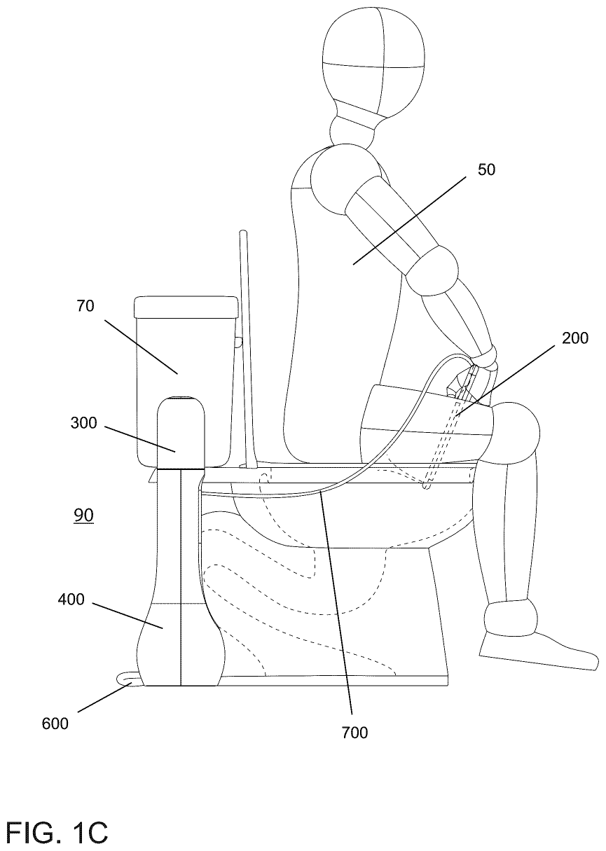

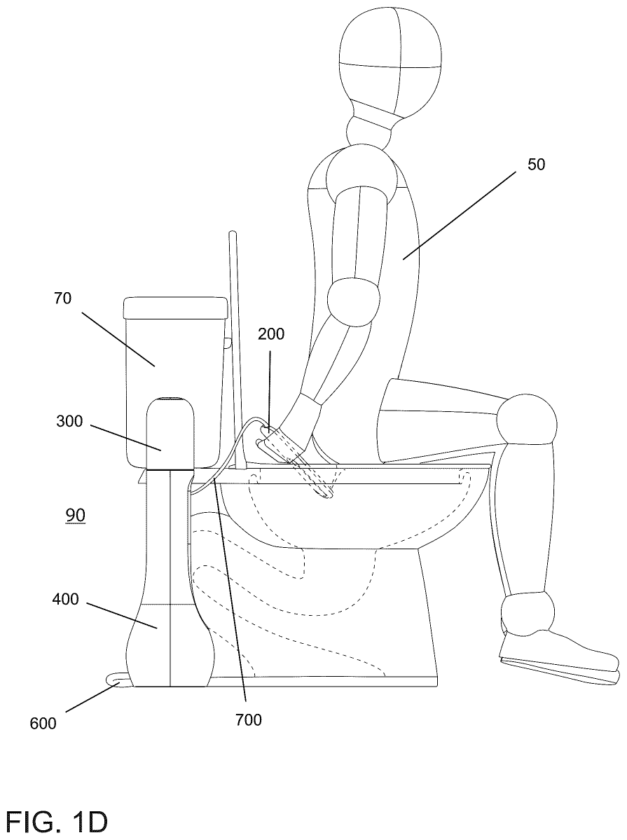

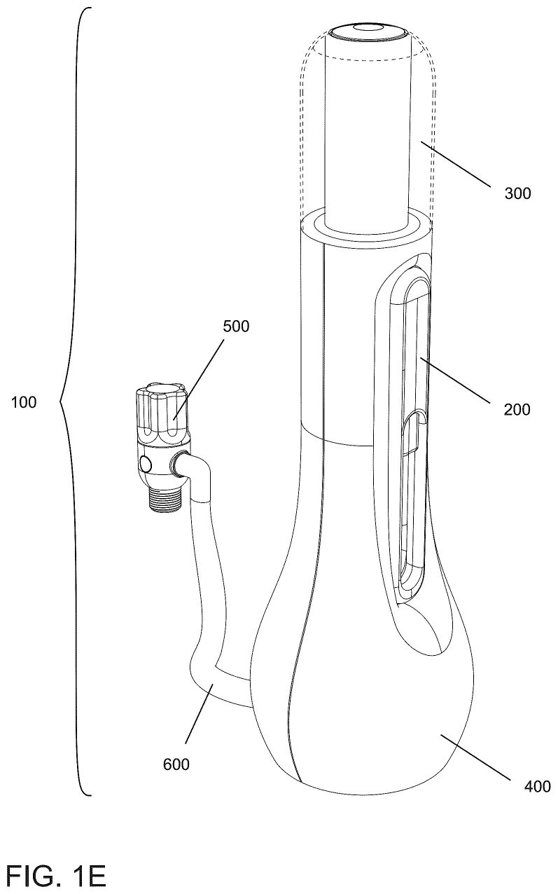

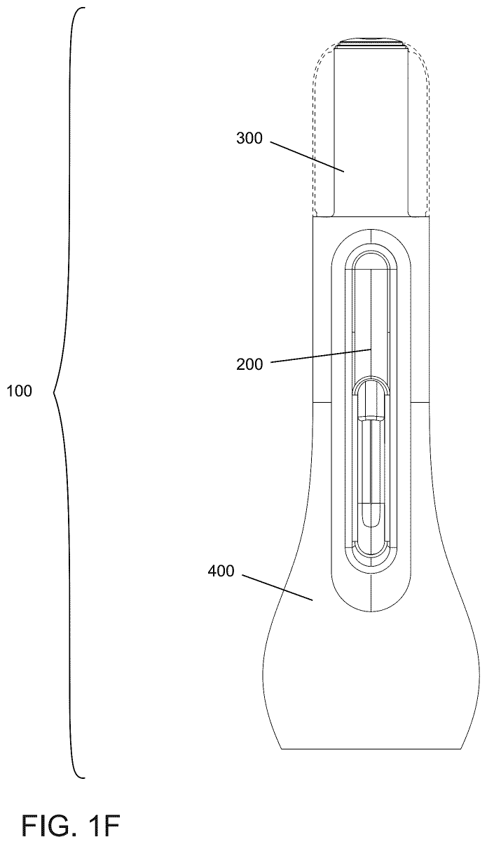

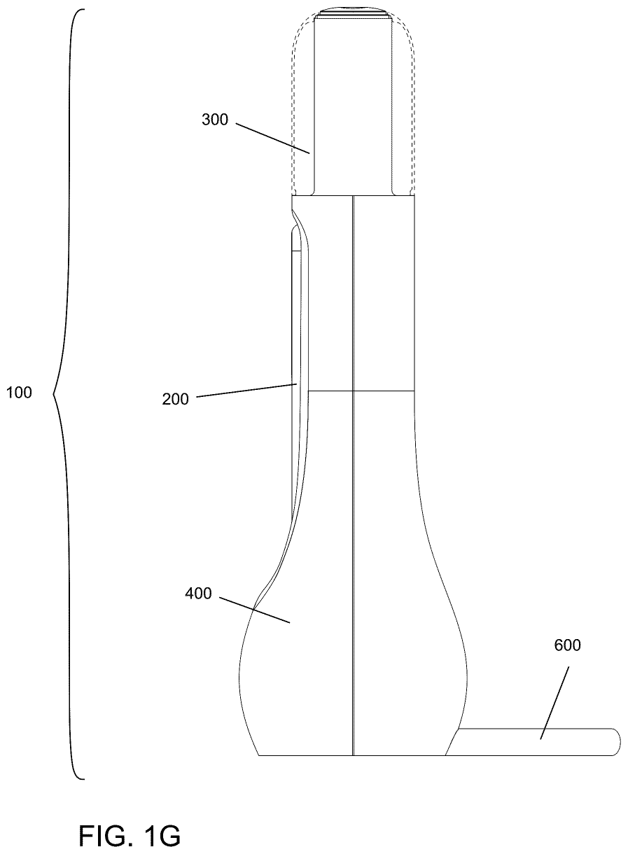

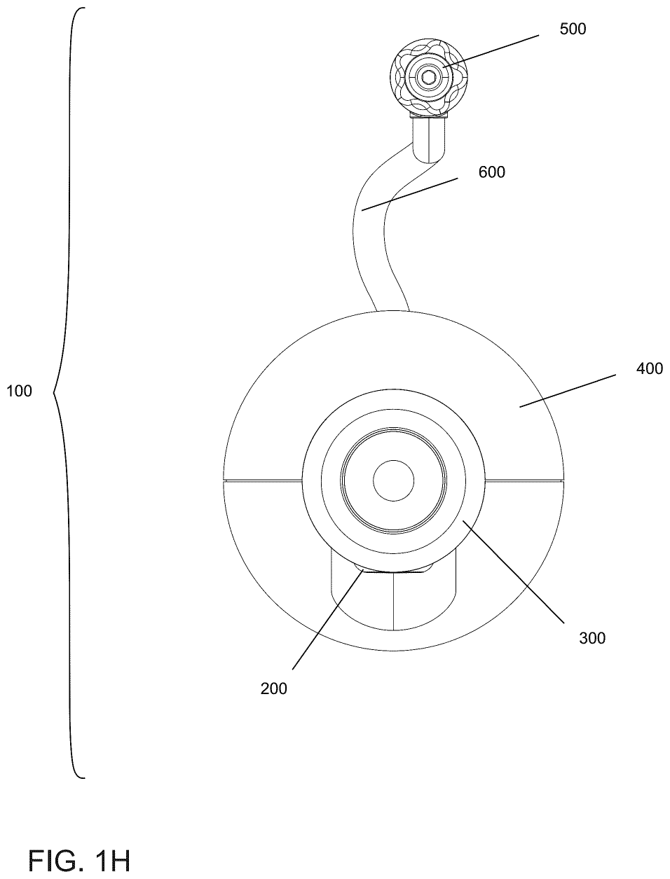

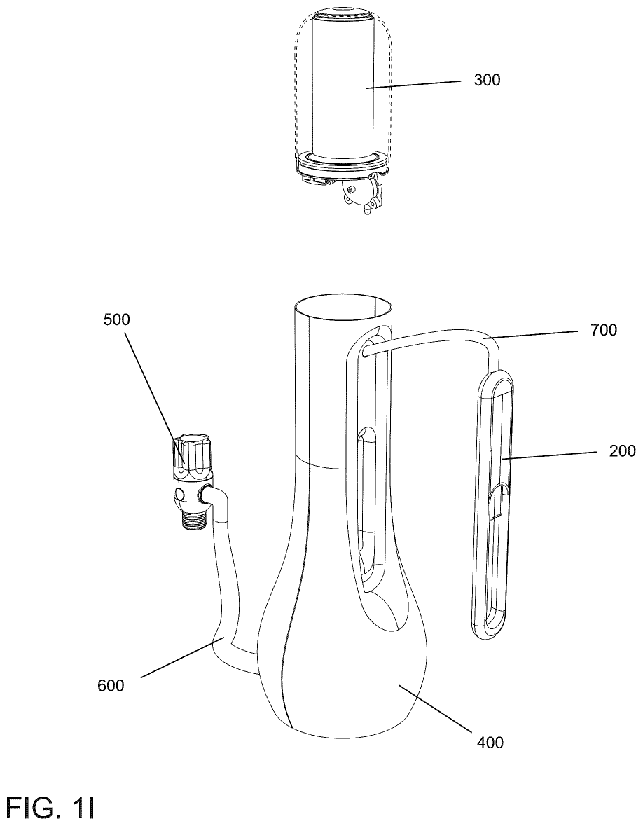

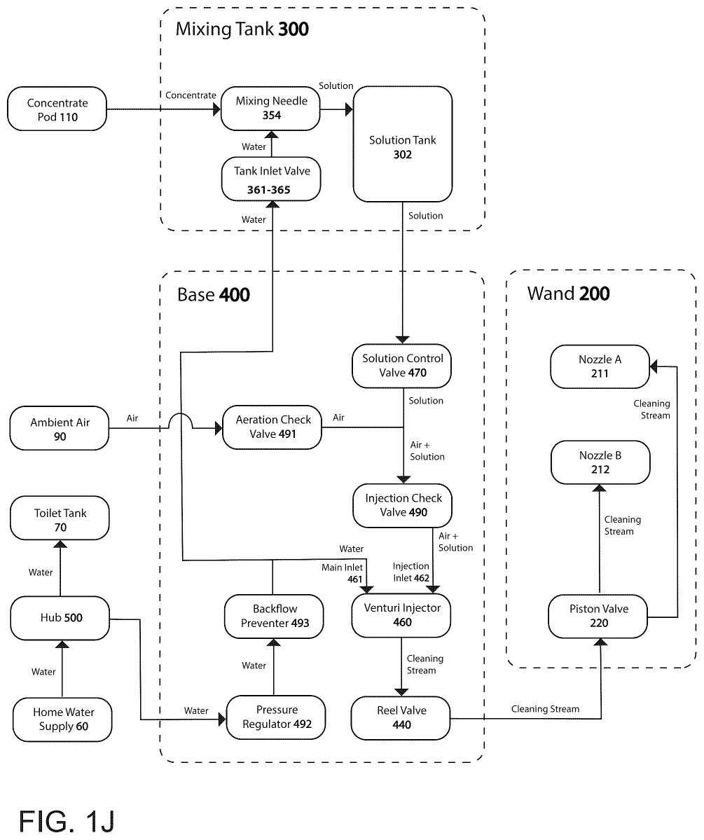

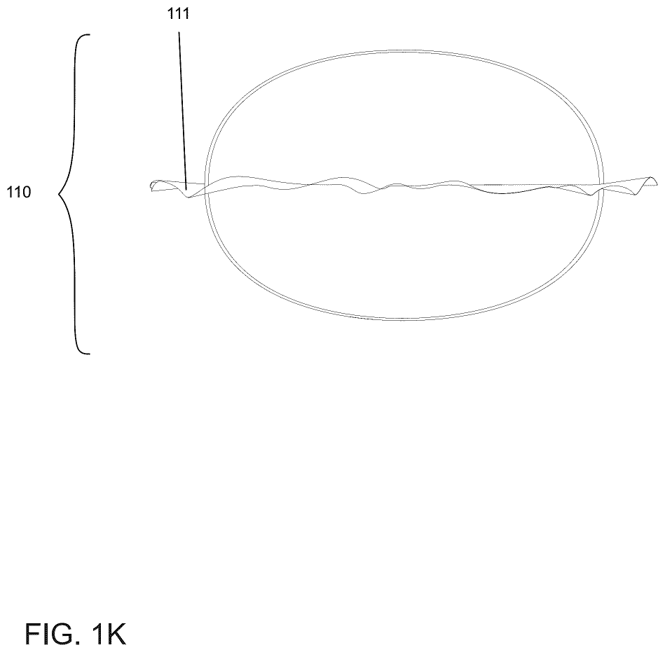

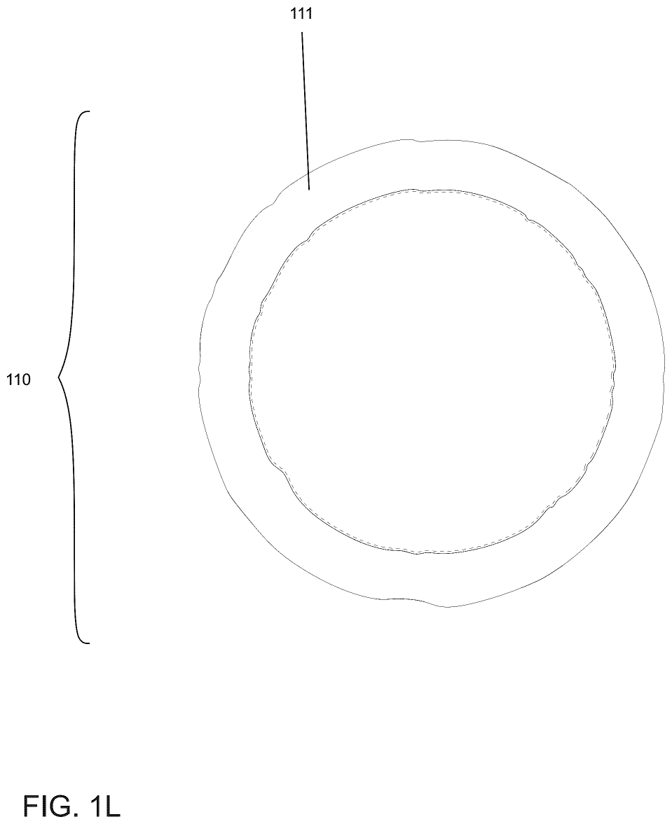

FIG. 1A illustrates a hygiene system 100 connected to a toilet via an inlet hose 600 connected to a hub 500 on a first end and a base 400 on a second end. The hygiene system 100 is further comprised of a base 400, a mixing tank 300 and a fluid applicator wand 200. FIG. 1A further illustrates the mixing tank in a closed configuration. The hygiene system 100 is positioned on the floor adjacent a toilet 40 having a toilet tank 70. The hygiene system 100 is surrounded by ambient air 90. The disclosed hygiene system 100 is not secured to the toilet seat 42 or the toilet bowl 44. Rather the disclosed hygiene systems sits on a surface 38 in proximity to the toilet 40 and the toilet bowl 44.

FIG. 1B illustrates the mixing tank 300 with the mixing core (described below) in an extended position to expose the pod insertion slot. FIG. 1C illustrates the hygiene system 100 in use with a user 50, such as a female user, applying the fluid applicator wand 200 from an anterior position. FIG. 1D illustrates the hygiene system 100 in use with a user 50, such as a male user, applying the fluid applicator wand 200 from a posterior position. FIG. 1E is a close-up view of the hygiene system 100 from a perspective view. FIG. 1F is a close-up view of the hygiene system 100 from a front view showing the fluid applicator wand 200 nested within in recess on a front surface of the base 400 of the hygiene system 100. FIG. 1G is a close-up view of the hygiene system 100 from a side view. FIG. 1H is a close-up view of the hygiene system 100 from a top view. FIG. 1I is an exploded view of the hygiene system 100. FIG. 1J is a block diagram illustrating the components of the hygiene system 100 and communication paths between the components as discussed in more detail below. FIGS. 1K-L illustrates a concentrate pod 110. The concentrate pod 110 has a pod skirt 111 which extends from the body of the pod. The concentrate pod 110 can include cleaning material. The cleaning material can be a concentrate selected from the group comprising liquid, crystals, granules, power, tablet, and gelatin capsules. The concentrate can also comprises one or more of each of a fragrance, a surfactant, a cleaning agent, an antibacterial, a scrubbing agent, an emollient, a prebiotic, and a post-biotic. Additionally, the concentrate can be scented or unscented.

### II. Fluid Applicator

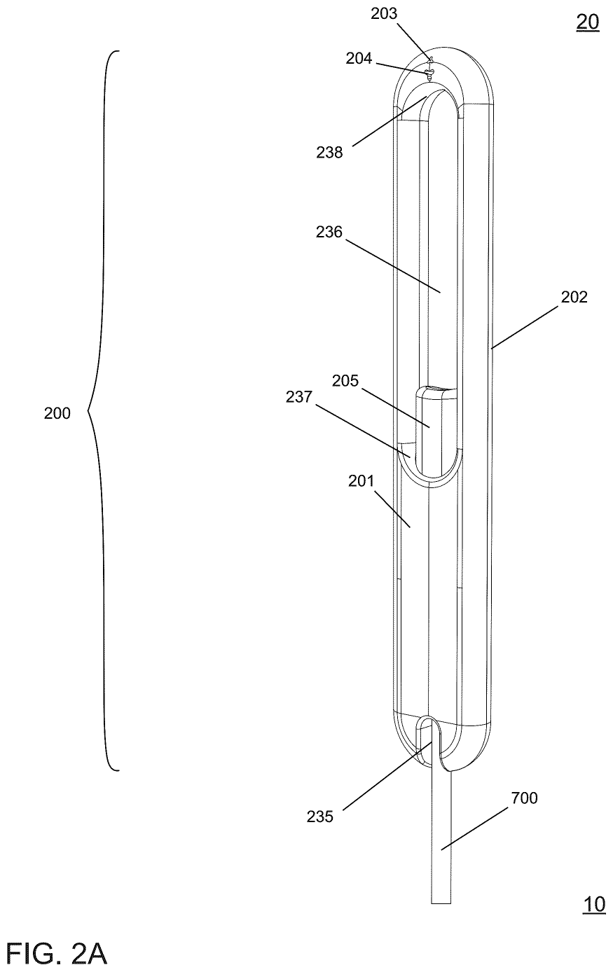

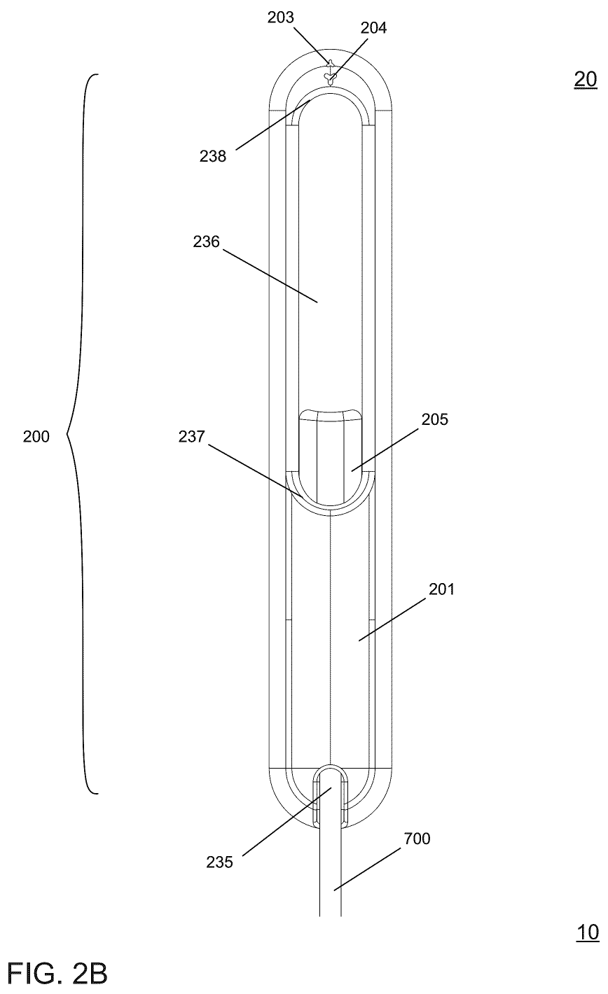

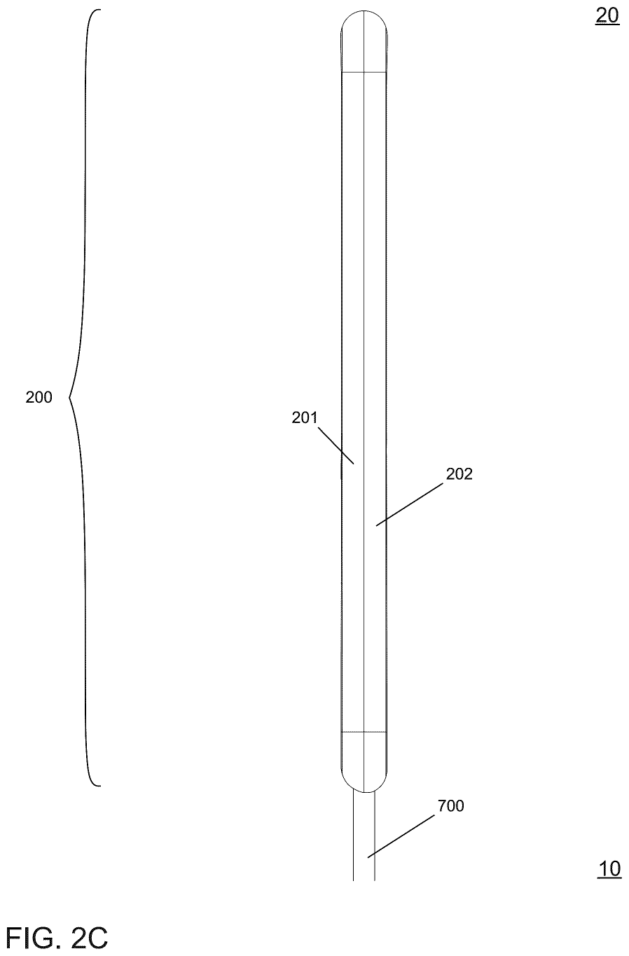

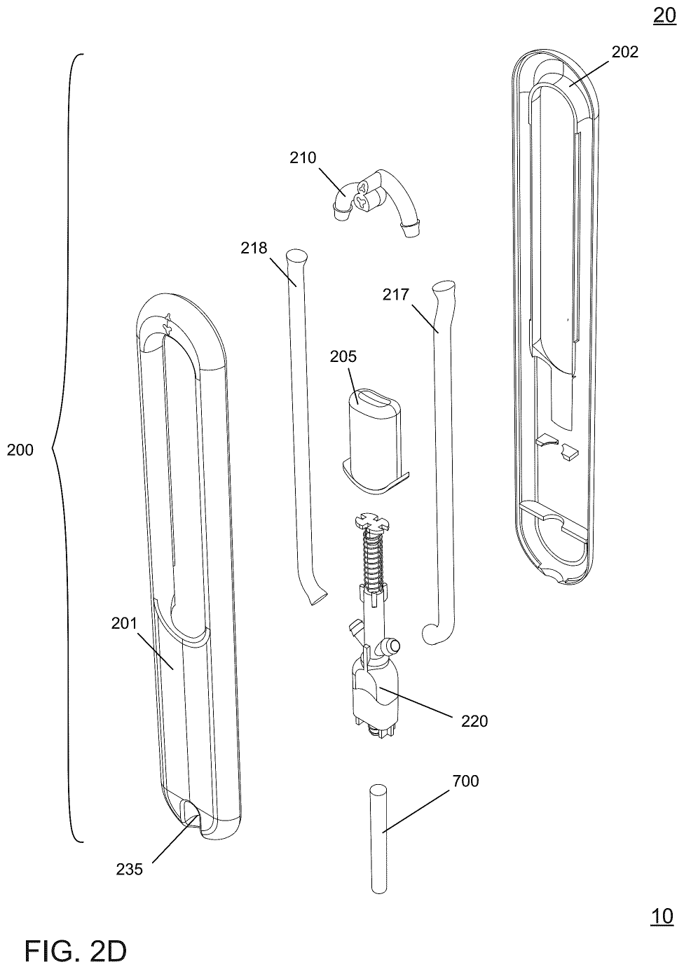

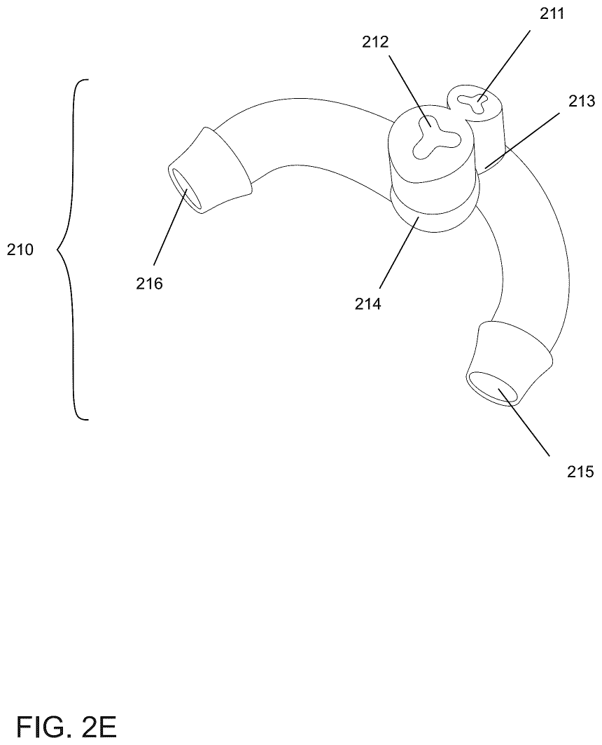

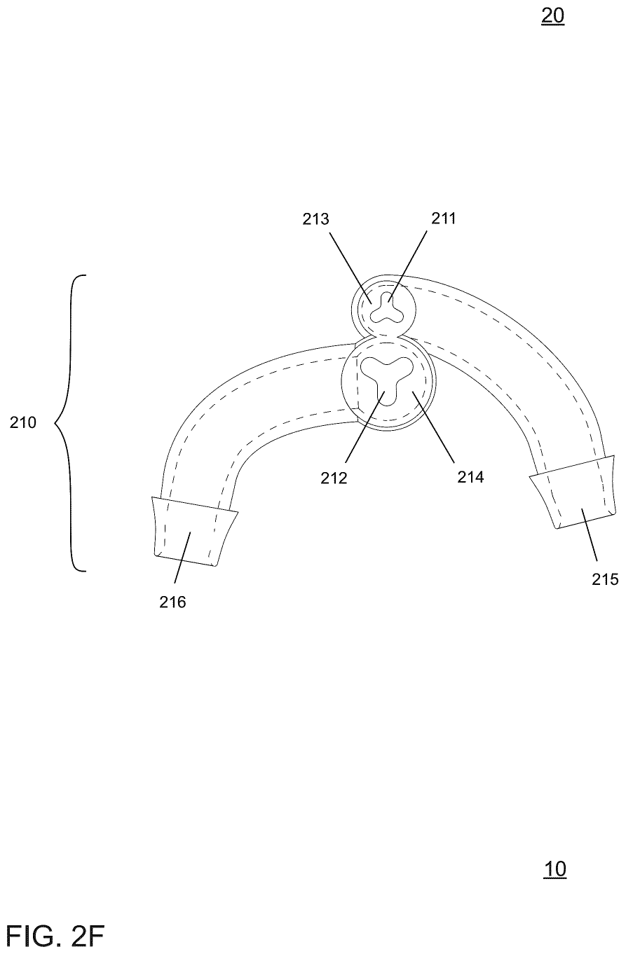

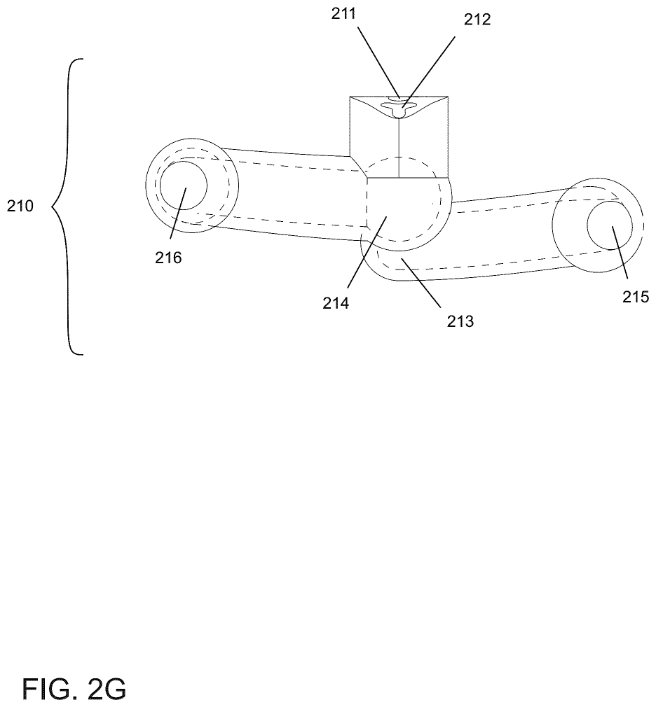

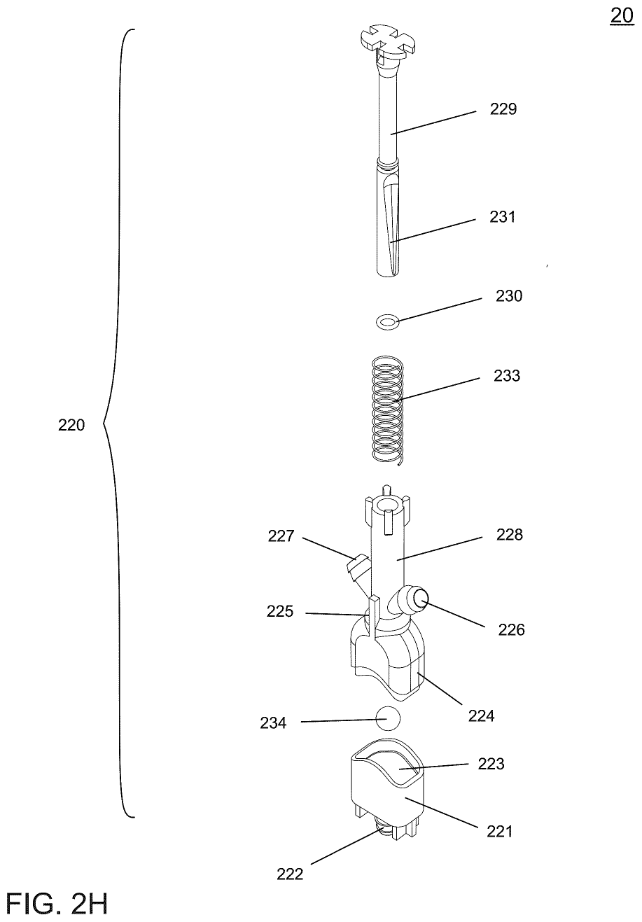

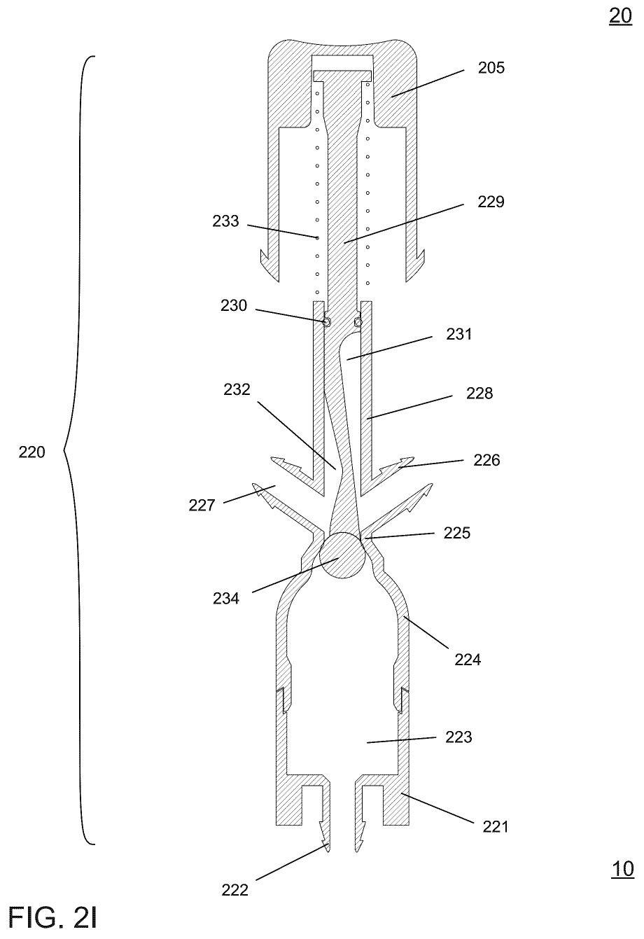

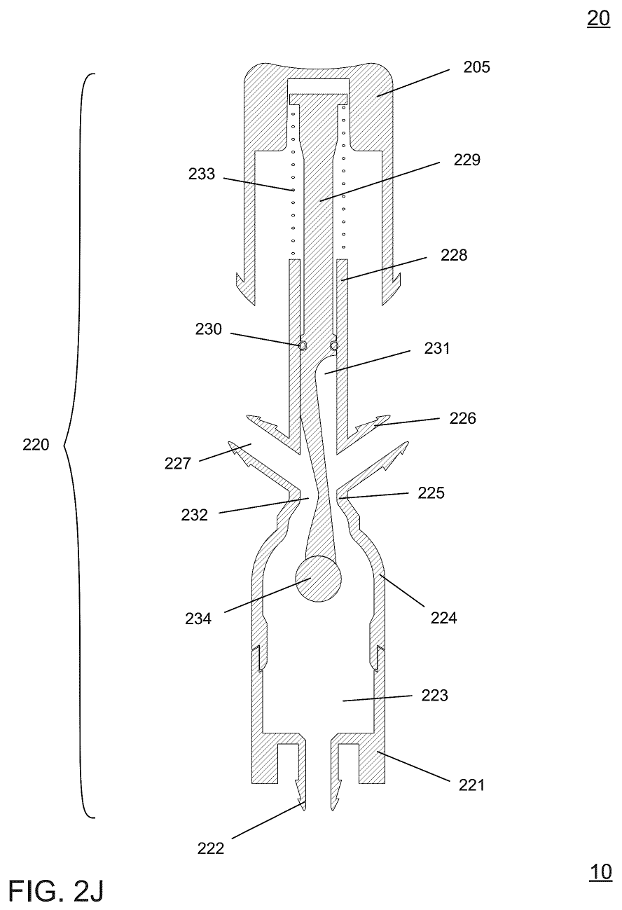

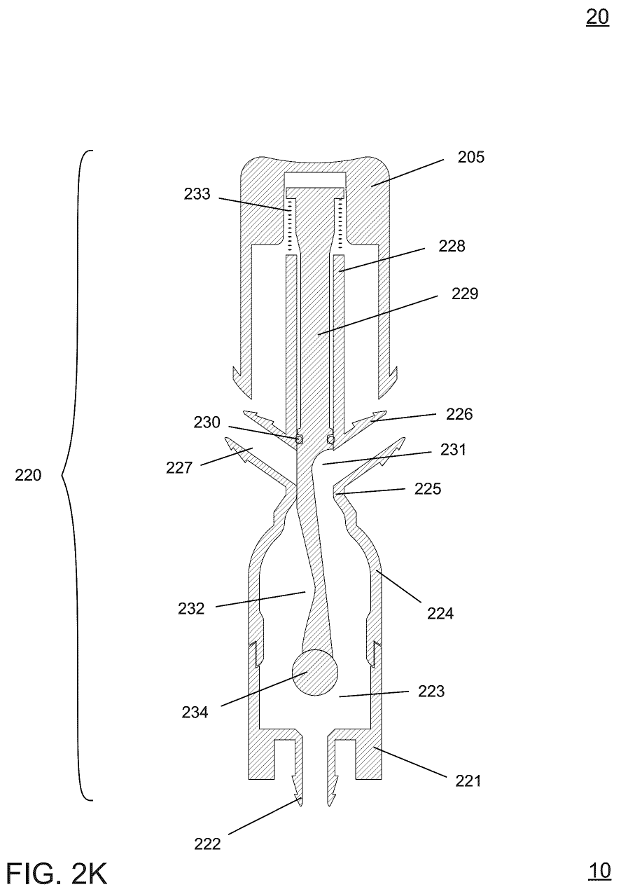

FIGS. 2A-K illustrate an exemplar fluid applicator wand 200 of a personal hygiene washing device or system. The system includes a fluid applicator wand 200. As shown in FIG. 2A, the fluid applicator wand 200 has a proximal end 10 a distal end 20, and a front wand housing 201. The proximal end 10 is closest to a user's hand and the distal end 20 is closest to where the fluid applicator wand 200 will deliver fluid.

The fluid applicator wand 200 has a width along an x-axis of from 30 mm to 50 mm, more preferably 40 mm, and a length along a y-axis of from 225 mm to 275 mm, more preferably 257 mm. The fluid applicator wand 200 is illustrated as an elongated rectangle with a curved proximal end 10 and a curved distal end 20. As will be appreciated by those skilled in the art, other shapes can be used without departing from the scope of the disclosure.

The ergonomic shape of the fluid applicator wand 200 is optimized to accommodate use of the fluid applicator wand 200 with both male anatomy and female anatomy as appreciated in reference to FIGS. 1C-1D. For female anatomy, the fluid applicator wand 200 can be positioned to access the vagina and urethra from an anterior (front) position. Reaching further, from an anterior anatomical position allows access to the anal region with female anatomy. For male anatomy, the fluid applicator wand 200 easily reaches the anal region by reaching under the buttocks (i.e. reaching from a posterior (rear) anatomical position).

The proximal end 10 of the fluid applicator wand 200 has an aperture 235 for receiving a fluid carrying tubing 700. An elongated central housing aperture 236. The elongated central housing aperture 236 can be positioned to extend from approximately midway along a y-axis of the fluid applicator wand 200 toward the distal end 20. The elongated central housing aperture 236 has a width less than the width of the fluid applicator wand 200 and a length less than the fluid applicator wand 200. A suitable width for the elongated central housing aperture 236 is from 15 mm to 30 mm, more preferably 21 mm, and a suitable length for the central aperture is from 100 mm to 240 mm. The elongated central housing aperture 236 is sized to minimize splash back hitting the fluid applicator wand 200 or user 50 during use as the bulk of any splash back would pass through the elongated central housing aperture 236 into the toilet bowl. As illustrated, the elongated central housing aperture 236 has an apertures shape, such as a curved proximal opening shape 237 and a curved distal opening shape 238. A wand actuator 205 is accessible via the elongated central housing aperture 236. The wand actuator 205 is positioned at the proximal end 10 of the elongated central housing aperture 236. The wand actuator 205 can be a trigger button that, in use, is pulled in a proximal direction to start the flow of fluid and released distally to stop the flow of fluid. Moving the wand actuator in a first direction or a second direction can increase total fluid delivery through one or both apertures or reduce fluid delivery through the one or both apertures. Two fluid delivery apertures are provided at the distal end 20. The fluid delivery apertures do not pass through the housing of the fluid applicator wand and are positioned adjacent one another. The first fluid delivery aperture 203 of the fluid delivery apertures, is a nozzle opening that allows for a straight stream of fluid to exit the fluid applicator wand 200 when the actuator 209 is activated by a user. The second fluid delivery aperture 204 is a nozzle opening that also allows for a straight stream of fluid to exit the fluid applicator wand 200 when the actuator 209 is activated by a user. In use, one or both of the first fluid delivery aperture 203, and the second fluid delivery aperture 204 can be in use to deliver a desired fluid pressure (e.g., applied fluid pressure) to the user. As illustrated, the apertures have a triangular shape with concave sides. Other shapes can be used without departing from the scope of the disclosure including, circular, square, triangular, rectangular, oval, and ovoid. Additionally, the first aperture can be a plurality of apertures of a first size and the second aperture can be a plurality of apertures of a second size, different than the first size, without departing from the scope of the disclosure.

FIG. 2B illustrates a front view of the fluid applicator wand 200 with the front wand housing 201 and first fluid delivery aperture 203, and second fluid delivery aperture 204 with the wand actuator 205 accessible via the elongated central housing aperture 236.

FIG. 2C illustrates a side view of the fluid applicator wand 200 with the front wand housing 201 and the rear washing wand case 202. The washing wand 200 has a thickness in a z-axis of from 10 mm to 20 mm, more preferably 15.2 mm.

FIG. 2D is an exploded view of the fluid applicator wand 200. From the exploded view, interior components of the fluid applicator wand are visible. The interior components are a nozzle piece 210, a wand actuator 205, a piston valve 220, a fluid carrying tubing 700, and a first interior wand tubing 217 and a second interior wand tubing 218. The piston valve is a moveable piston valve rod and has an upper piston ball housing and a lower piston housing.

Turning now to FIG. 2E, the nozzle piece 210 is shown in more detail. The nozzle piece 210 has a first nozzle chamber 213 and a second nozzle chamber 214. The nozzle chambers are in communication with a first inlet 215 and a second inlet 216. The first nozzle chamber 213 has a first wand nozzle aperture 211, and the second nozzle chamber 214 has a second wand nozzle aperture 212. FIG. 2F illustrates the nozzle piece 210 of FIG. 2E with the interior fluid communicating channels illustrated in dashed lines. FIG. 2G is a side view of the nozzle piece 210 with the interior fluid communicating channels shown.

Turning now to FIG. 2H, an exploded view of a piston valve 220 is illustrated. The piston valve 220 has a lower piston housing 221 with a piston lower inlet connector 222 at a first end and an a lower piston valve chamber 223. The lower piston housing chamber 223 has an opening sized to receive an upper piston valve housing 224. A piston valve ball 234 is positioned between the lower piston housing 221 and the upper piston valve housing 224 and sits within the piston valve chamber 223 when the lower piston housing 221 and upper piston valve housing 224 is connected, i.e., when the upper piston valve housing 224 is seated within the lower piston valve chamber 223. The upper piston valve housing has a piston valve throat 225 above which is a first piston valve outlet 226 and a second piston valve outlet 227. The first piston valve outlet 226 and the second piston valve outlet 227 as shown on opposite sides of the upper piston valve housing 224. A piston valve rod sheath 228 extends from the upper piston valve housing 224 beyond the two piston valve outlets 226, 227. The piston valve rod sheath 228 has a plurality of ribs that extend from the exterior surface of the piston valve rod sheath 228. A piston valve spring 233 is provided that is sized to engage the upper surface of the piston valve rod sheath 228 and nest between the plurality of ribs when the piston valve rod 229 is inserted into the piston valve rod sheath 228. A piston valve rod o-ring 230 is provided which fits around a recess in the piston valve rod 229 as shown in FIG. 2I. The upper end of the valve rod 229 has a head with a wider diameter than the diameter of the body of the piston valve rod 229. A Series of cavities are provided along a portion of the length of the body of the piston valve rod 229. The cavities are better appreciated with reference to the cross-section shown in FIG. 2I. The piston valve ball 234 is integrally formed with the piston valve rod 229 either as a single unit or two components that operate as a single unit. In one example, the piston valve ball 234 can be glued to the piston valve rod 229, or, in another example, the piston valve ball 234 is over-molded.

Turning now to FIGS. 2I-K, a cross-section of the piston valve 220 is illustrated. In FIG. 2I the piston valve ball 234 is positioned within the throat of the upper piston valve housing 224. From the cross-sectional view FIGS. 2I-K, it can be appreciated that as the piston valve rod 229 moves in a proximal and distal direction, one or both of a first cavity 231 and a second cavity 232 are in fluid communication with the piston valve chamber 223. Additionally, the first cavity 231 is in fluid communication with a first piston valve outlet 226, and the second cavity 232 is in fluid communication with a second piston valve outlet 227. When the piston valve rod 229 is in a proximal position (i.e., wand actuator 205 pressed completely down) fluid accesses the first piston valve outlet 226, as the piston valve rod 229 is moved distally towards the wand actuator 205 (i.e., pressure is released from the wand actuator 205), fluid passes through both the first piston valve outlet 226 via the first cavity 231 and the second piston valve outlet 227 via the second cavity 232. As the piston valve rod 229 continues to move distally, fluid access begins to taper off to the first piston valve outlet 226. Once the piston valve rod 229 is at its distal most position, the piston valve ball 234 sets within the piston valve throat 225 of the upper piston valve housing 224 to stop fluid communication. As pressure is applied by the user to the wand actuator 205 to move the actuator in a proximal direction, the piston valve spring 233 is compressed which places tension on the spring. As pressure is released by the user from the wand actuator 205, the spring tension releases which facilitates movement of the wand actuator 205 to a starting position.

To start with, when the wand actuator 205 is lightly pressed by a user, fluid passes through both piston valve outlets at a ratio where the resulting speed of the fluid exiting the two nozzles is identical, resulting in both nozzles spraying fluid in what appears to be a coherent stream.

### III. Fluid Mixing Tank

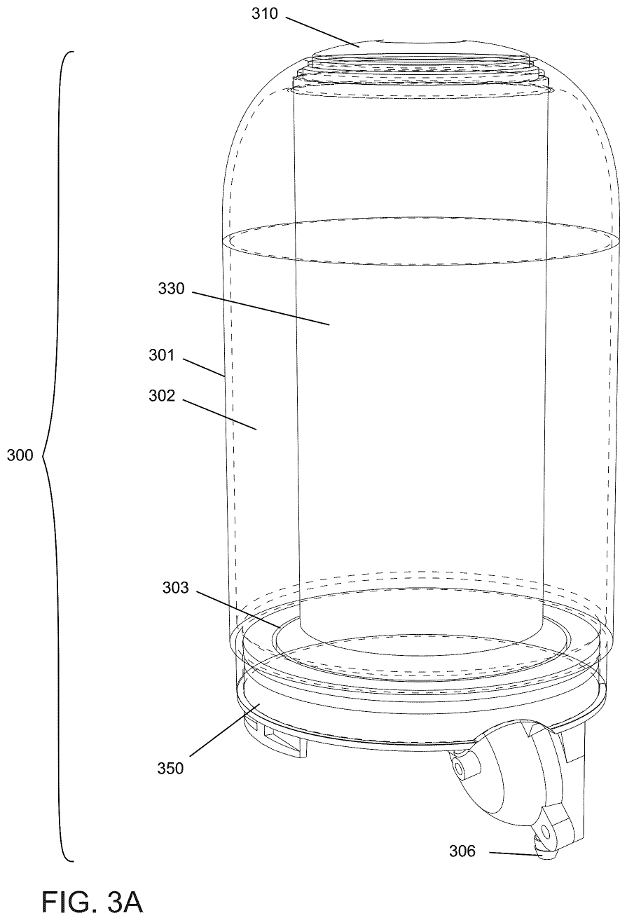

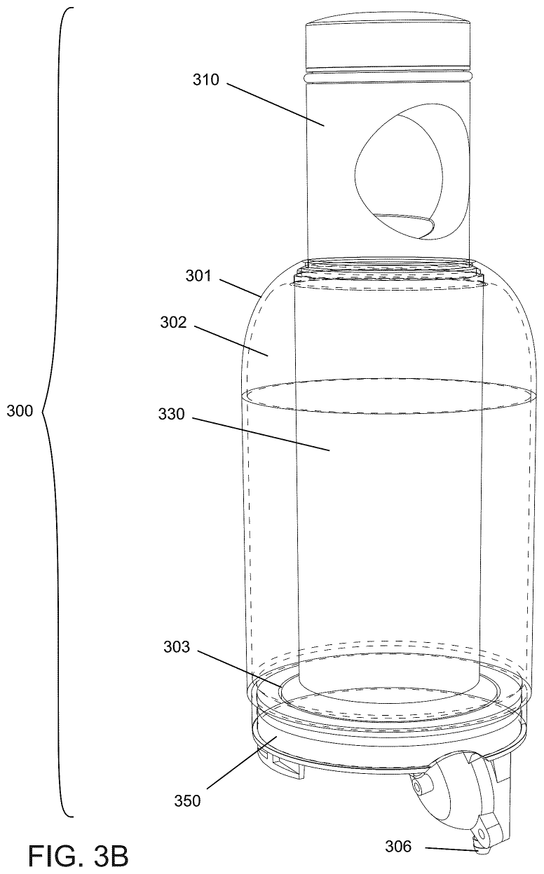

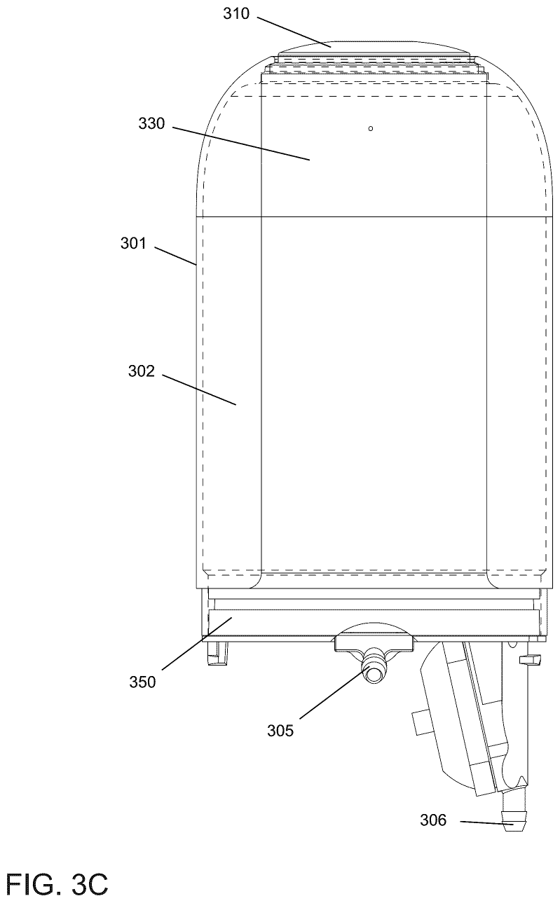

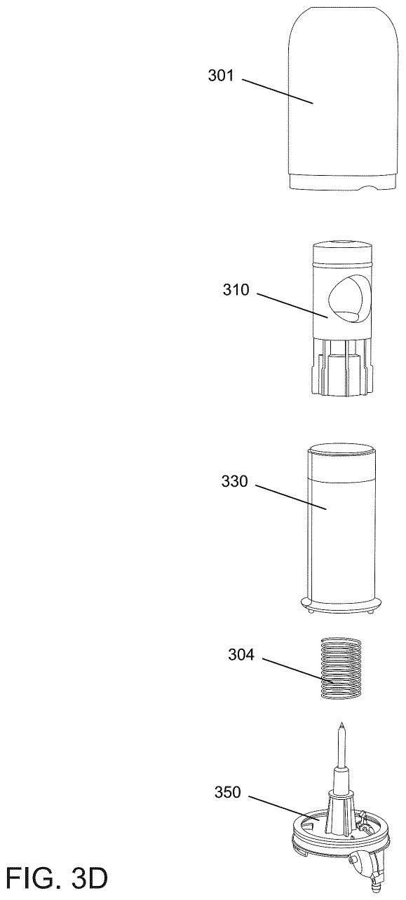

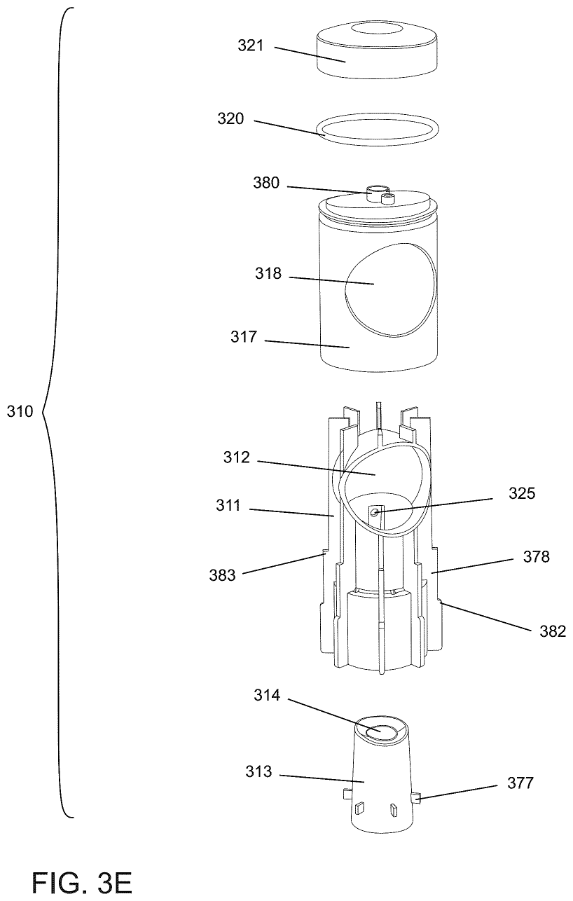

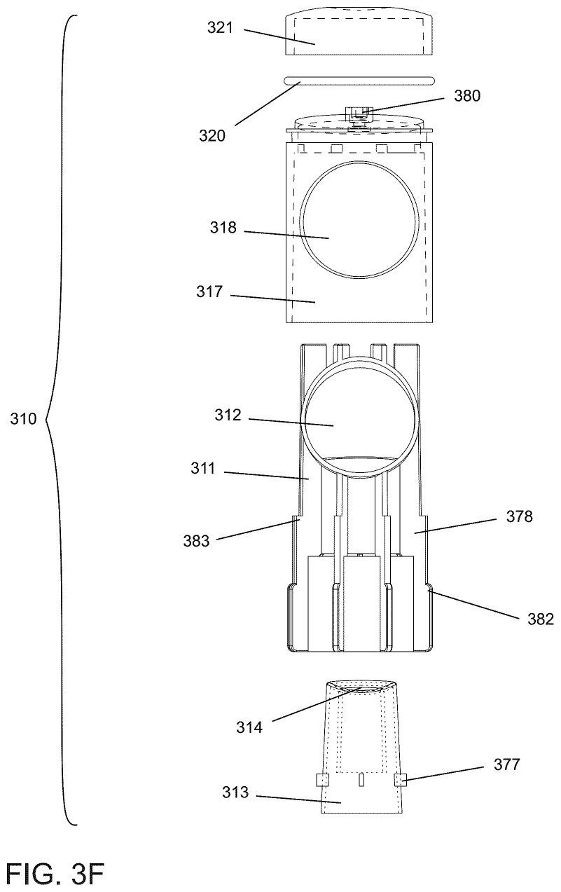

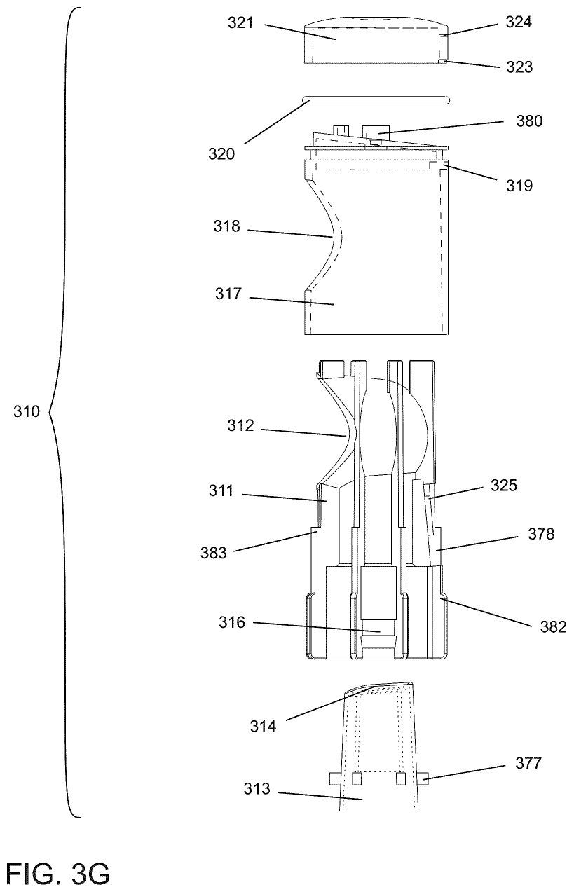

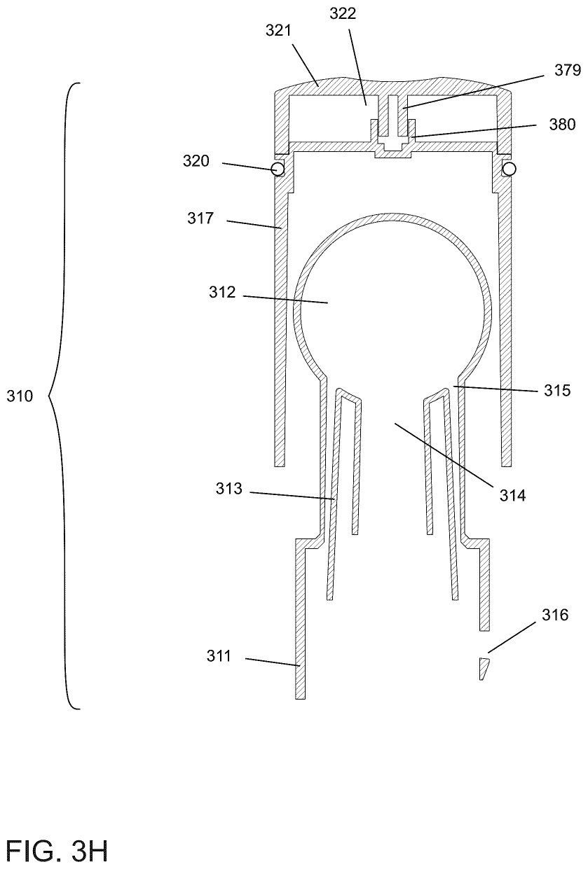

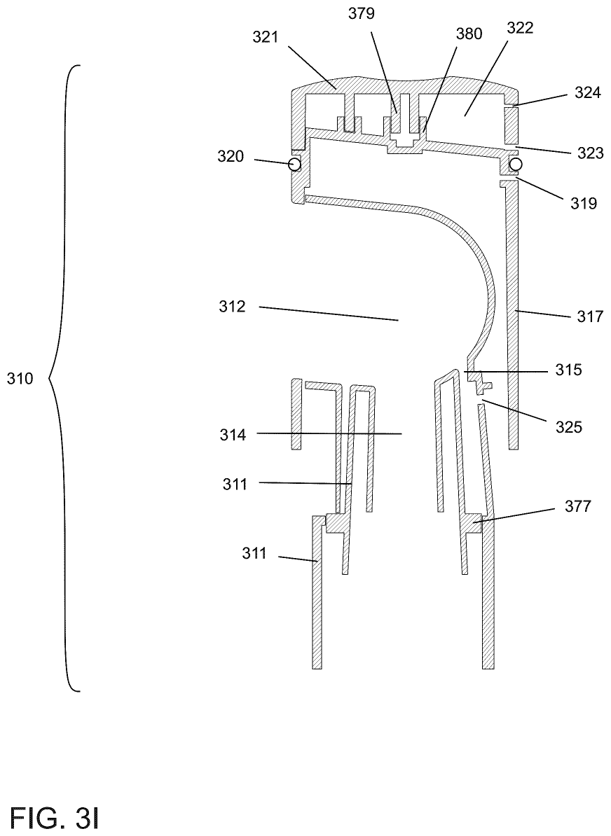

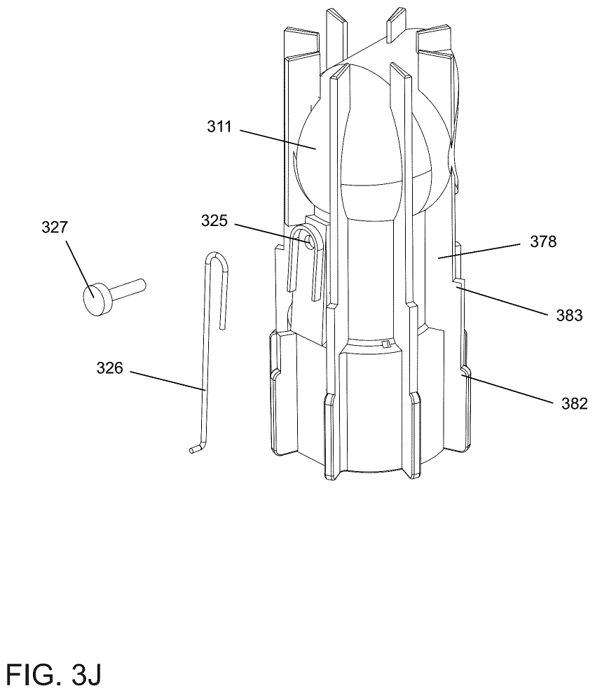

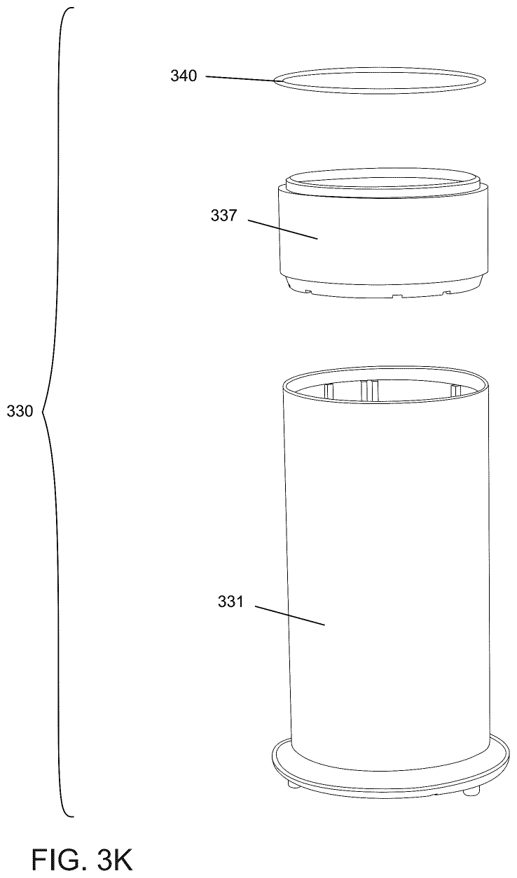

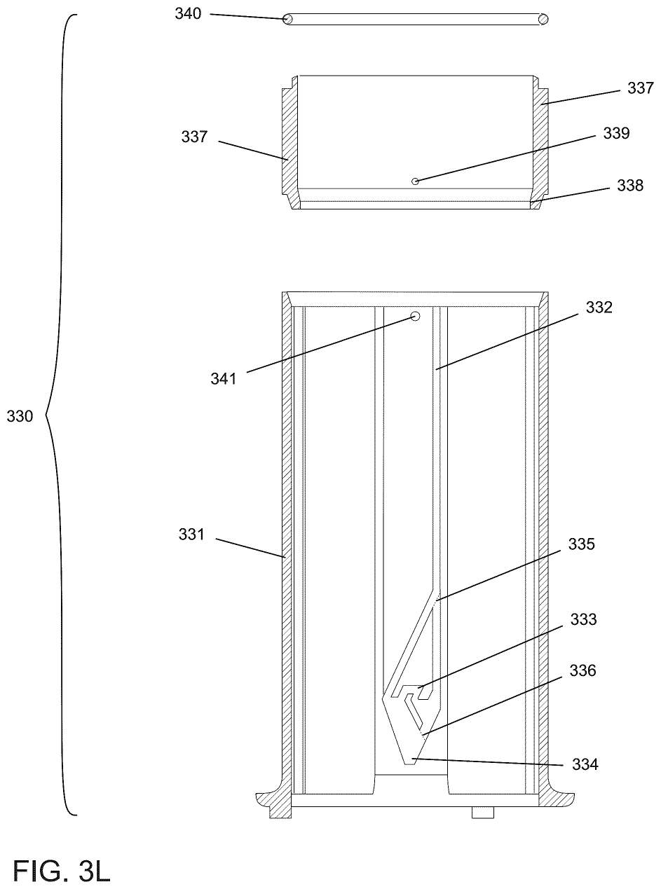

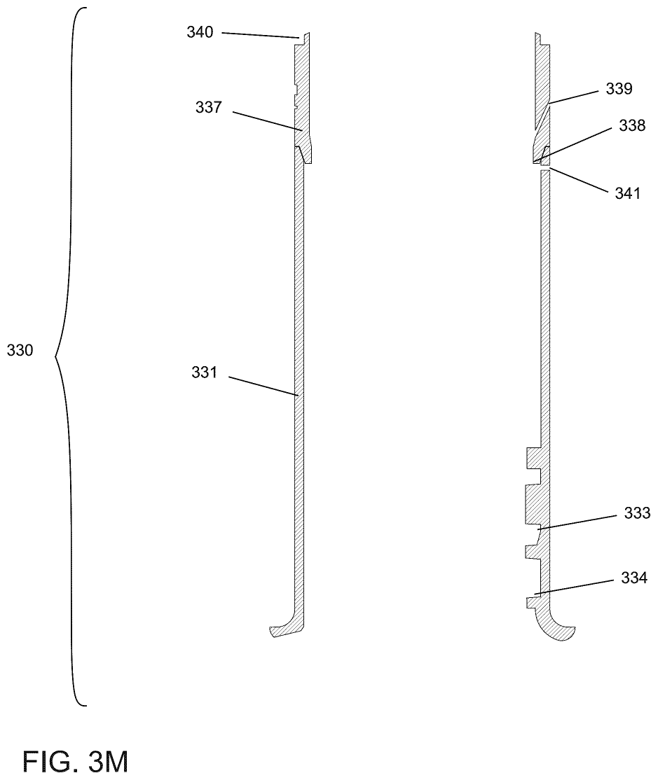

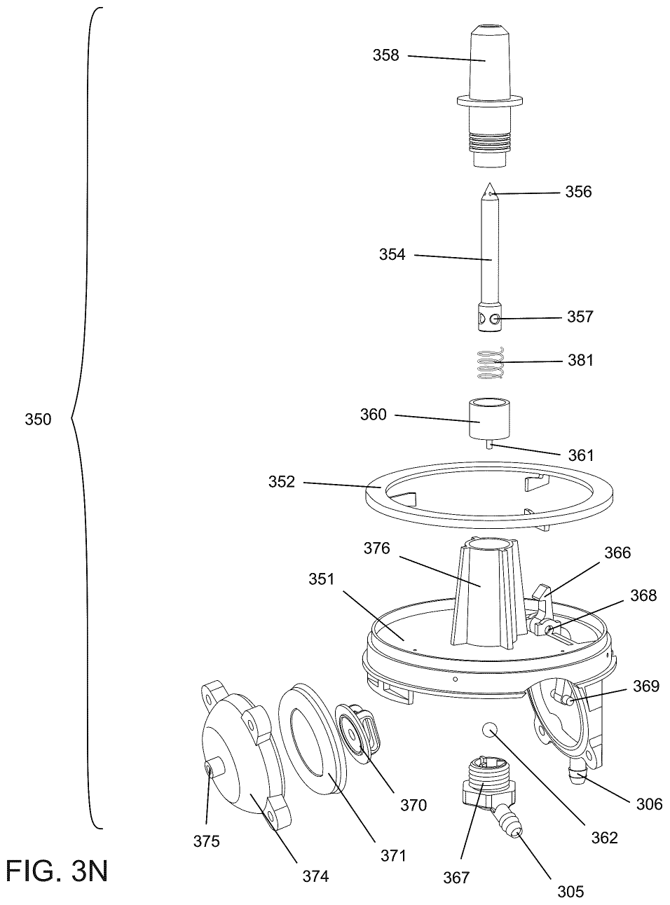

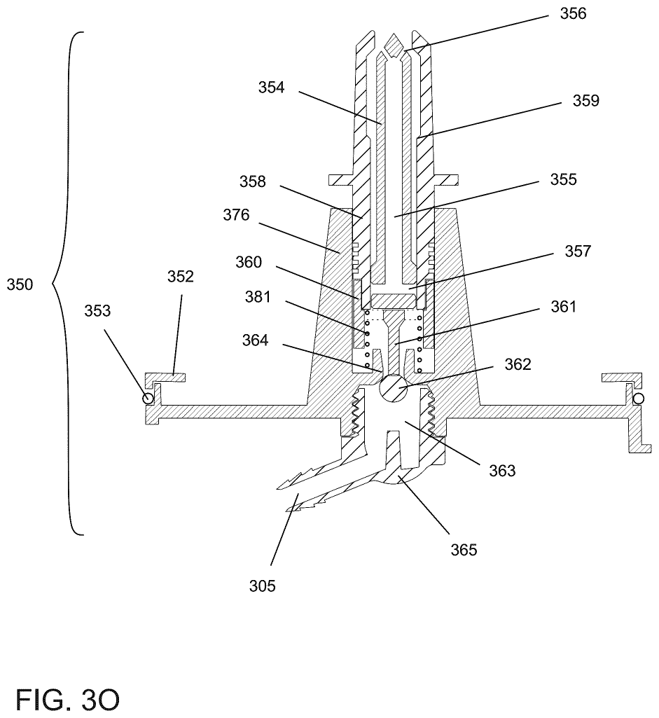

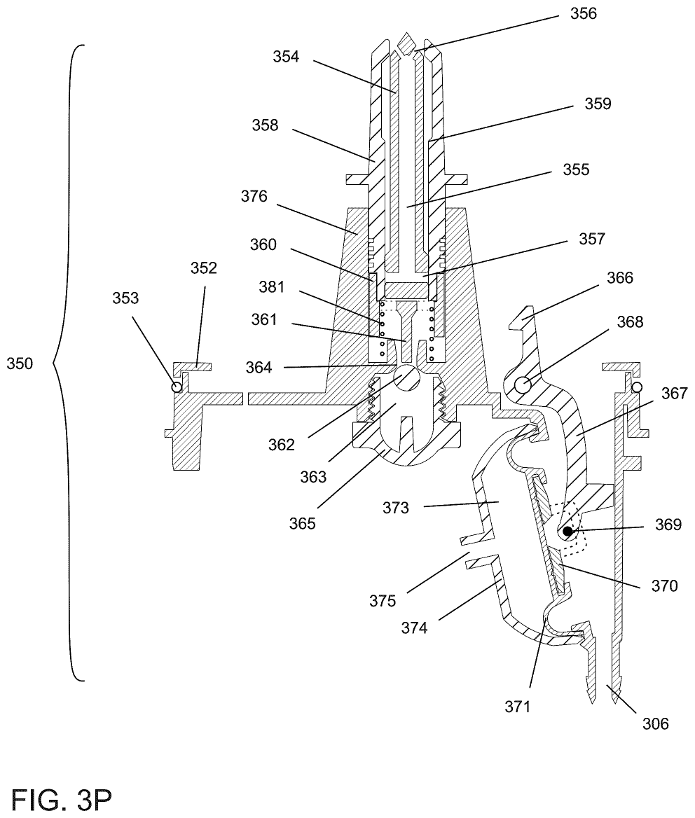

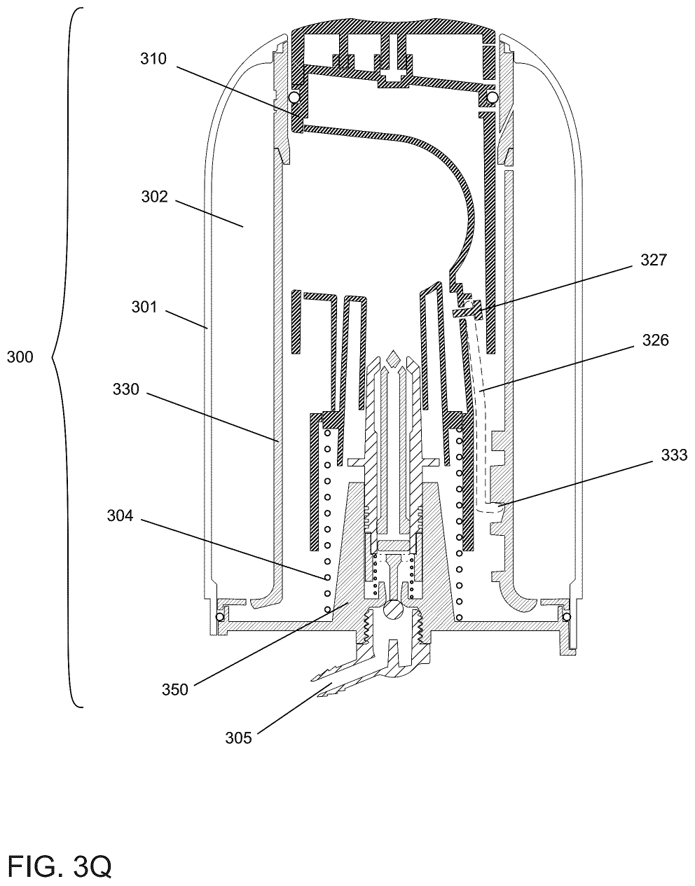

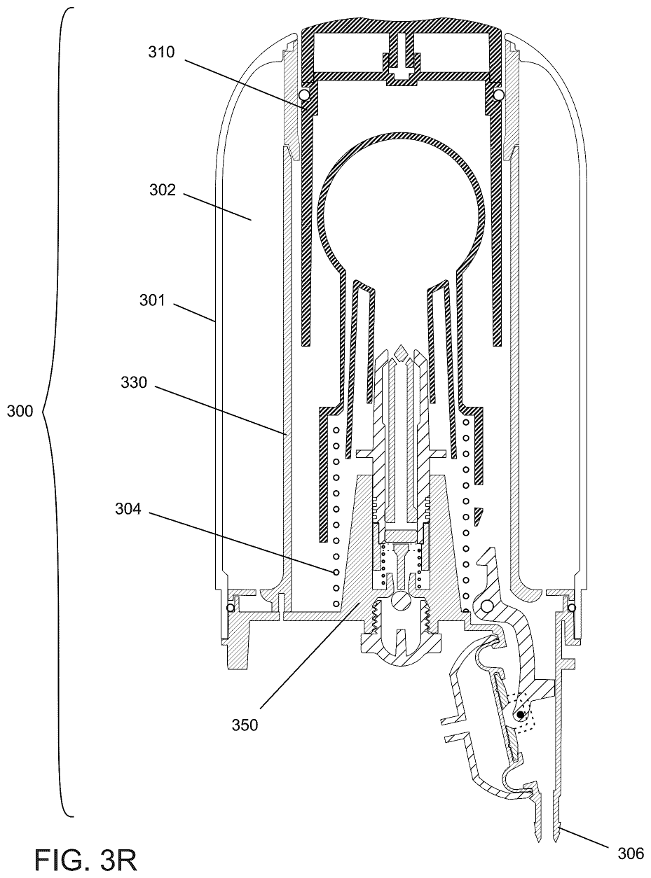

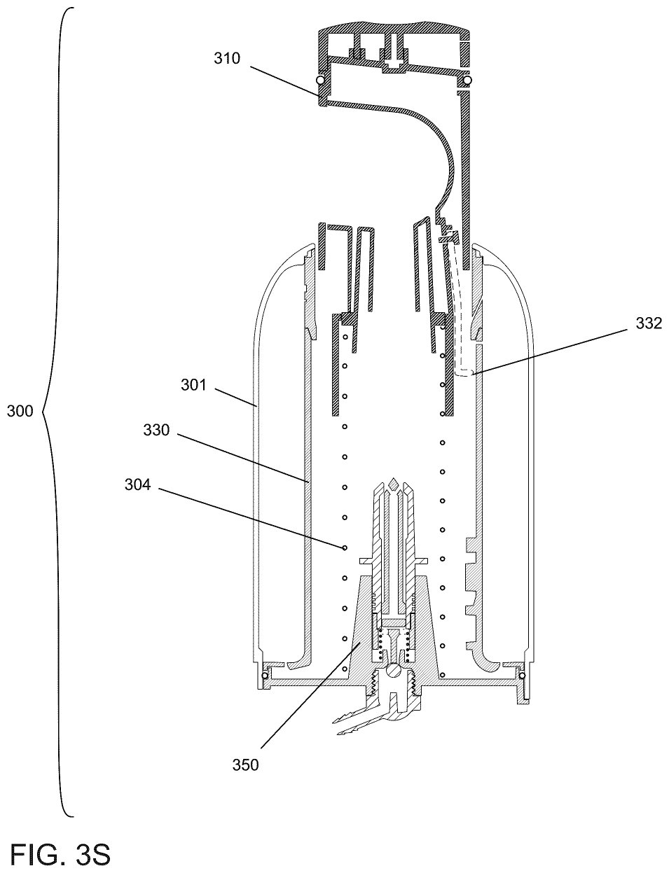

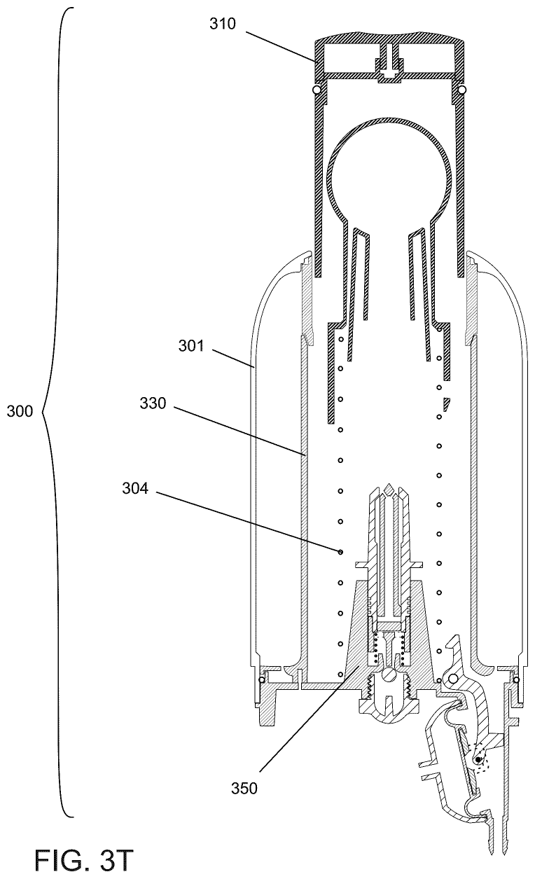

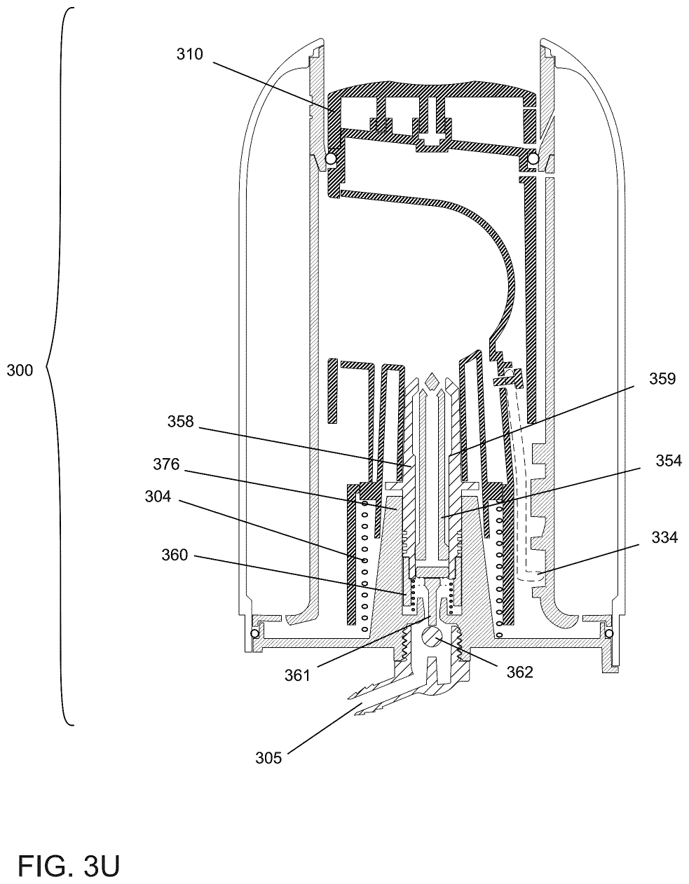

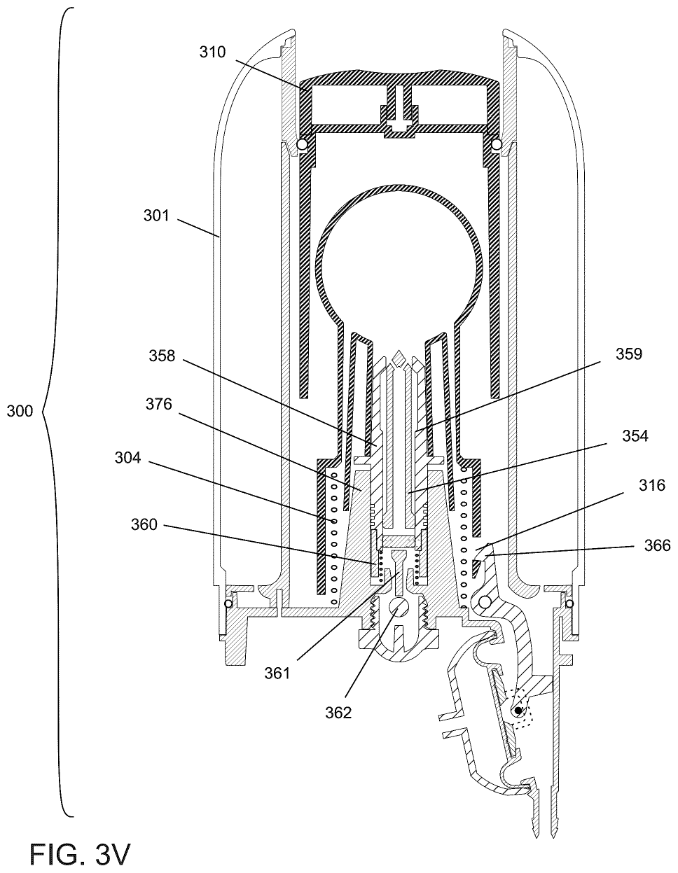

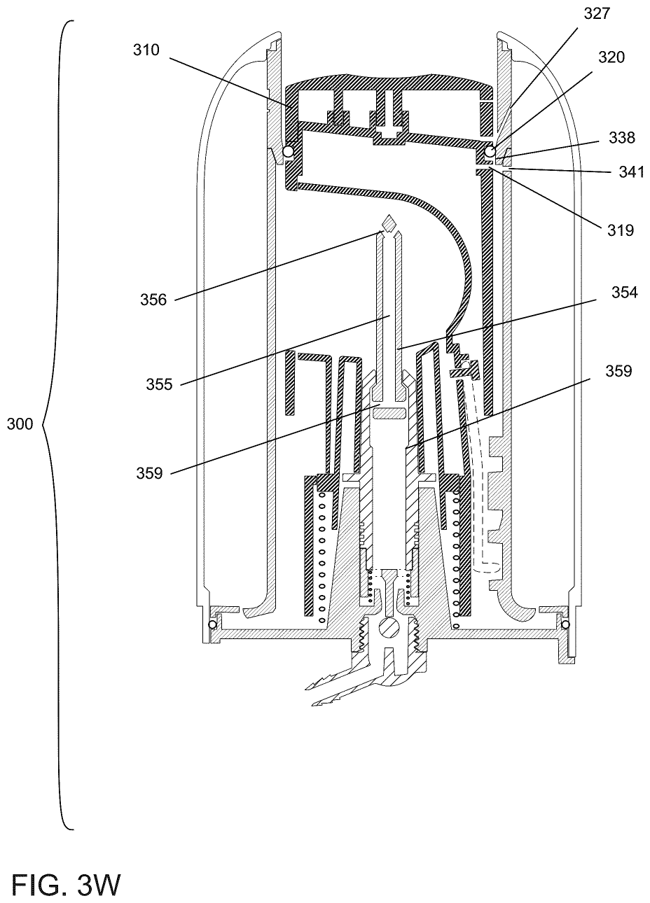

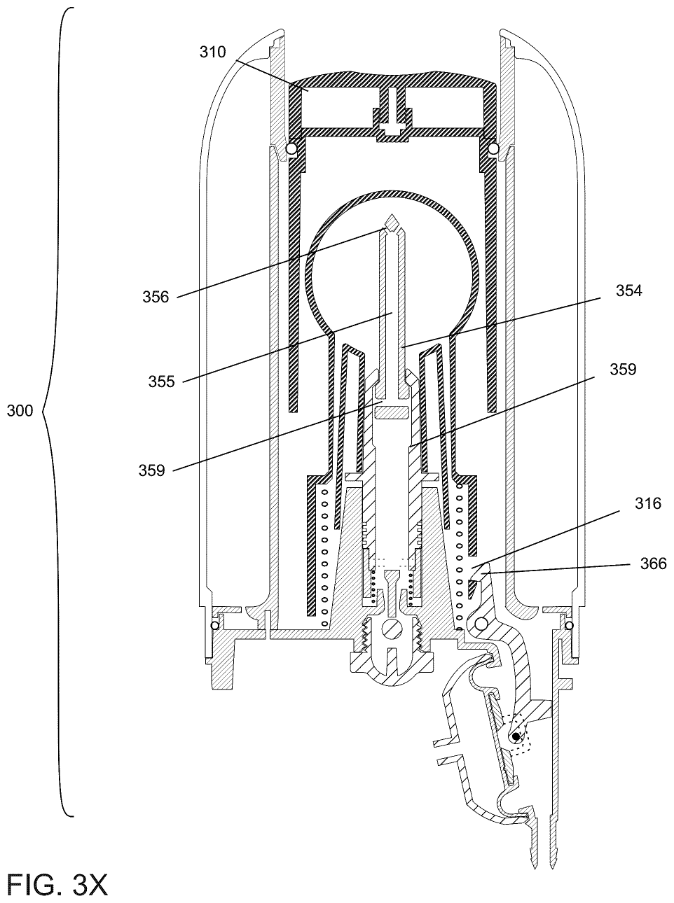

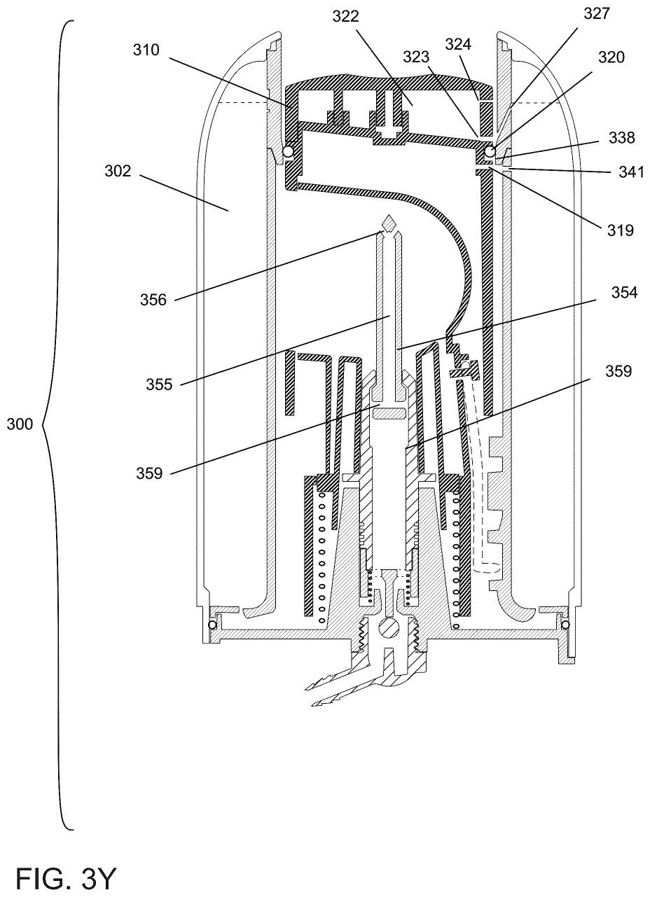

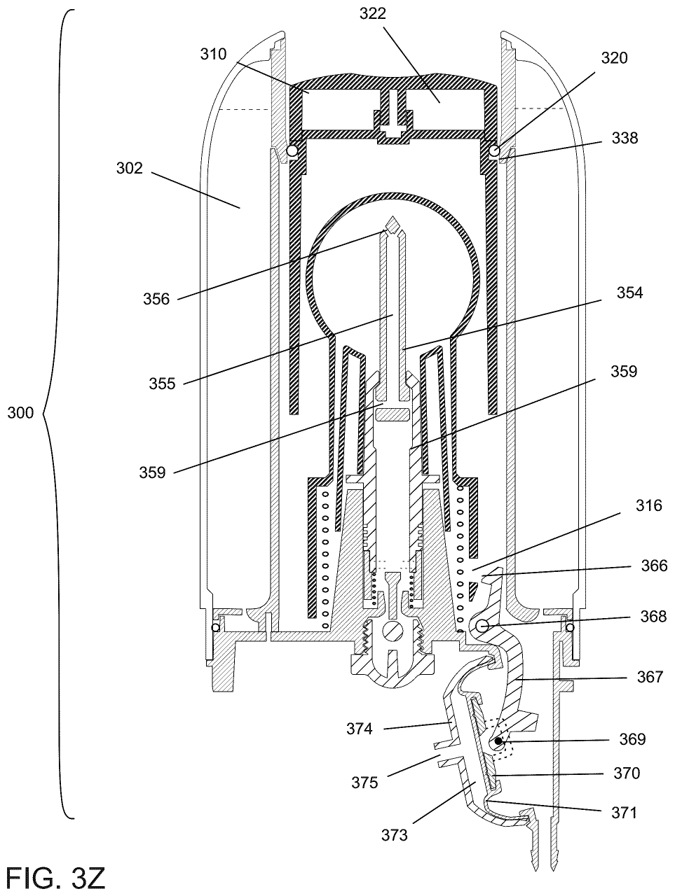

FIGS. 3A-3Z illustrate a mixing tank 300. The mixing tank 300, mixing tank apparatus, has four main components: an outer shell 301, a tank column assembly 330 which is configured to be positioned within the outer shell 301, a mixing core assembly 310 which engages the tank column assembly 330, and a tank lower assembly 350 that includes the needle 354. The needle 354 can be telescoping and facilitate mixing. The outer shell 301 forms a tight seal with the tank column assembly 330. The flushing needle can also be operable to project upward.

FIG. 3A illustrates the mixing tank 300 with the mixing core assembly 310 in a closed position with the core assembly 310 nested within the tank column assembly 330. FIG. 3B illustrates the mixing tank 300 with the mixing core assembly 310 in an open/extended position with the core assembly 310 extended upward from the outer shell 301. The mixing tank 300 has a height of from 125 mm to 200 mm, more preferably 140 mm, and a diameter of from 75 mm to 150 mm, more preferably 91 mm, when the tank column assembly 330 is in the closed position and a height of from 150 mm to 250 mm, more preferably 205 mm when the tank column assembly 330 is in the open/extended position. The mixing core assembly 310 has a length of from 50 mm to 80 mm, more preferably 70 mm, and a diameter of from 40 mm to 60 mm, more preferably 49 mm.

The outer shell 301 has an outer wall and an inner wall that defines a tank cavity 302. The mixing tank 300 has a first mixing tank floor with a floor opening 303 at the bottom of the mixing tank cavity 302 and a second mixing tank floor below the first mixing tank floor. A mixing tank outlet connector 306 is provided which is in fluid communication with the mixing tank cavity 302. The mixing tank outlet connector 306 can be positioned at or near the bottom surface of the mixing tank 300 to facilitate release of fluid from the mixing tank 300 which benefits from gravity. The mixing tank outlet connector 306 can engage an autofill membrane air cavity 373. The autofill membrane air cavity 373 can also have an autofill membrane air cavity shell 374. A mixing core cap 321 is provided on an upper surface of the mixing tank 300.

As shown in FIG. 3B, the outer shell 301 has a cavity between the inner surface of the outer shell 301 which slidably receives the tank column assembly 330. The mixing tank outlet connector 306 can engage an autofill membrane air cavity 373. The autofill membrane air cavity 373 is filled with air on a side of the membrane opposite the tank. The autofill membrane air cavity 373 can also have an autofill membrane air cavity shell 374. The mixing core cap 321 is adjacent a mixing core sealing o-ring 320 as shown in FIGS. 3E-I. FIG. 3C shows the mixing tank 300 with the mixing tank inlet connector 305 in a front location and the mixing tank outlet connector 306, to one side.

FIGS. 3D-G illustrate various exploded views. In FIG. 3D, the tank lower assembly 350 is shown with the needle 354 extending from a needle base 376 positioned on the surface of the interior facing surface of the tank lower assembly. A mixing core spring 304 is positioned so that it fits around the needle 354 and rests on an interior facing ledge of the needle base 376. The mixing tank column assembly 330 fits around the needle 354 and needle base 376 and is removably and securely coupled to the tank lower assembly 350 such as by threaded engagement. The mixing core assembly 310 nests within the mixing tank column assembly 330 and the outer shell 301 fits around the mixing core assembly 310 and the mixing tank column assembly 330. The outer shell 301 is securely coupled to the tank lower assembly 350 such as by a snap or latch arrangement.

FIGS. 3E-G show an exploded view of the mixing core assembly 310 from a partial side view, a front view and a side view (turned 90 degrees from the front view). The mixing core assembly 310 has a mixing core chamber floor 313 with a mixing core chamber needle aperture 314. A series of protrusions 377 are positioned below the mixing core chamber needle aperture 314 of the mixing tank lower assembly 350 which are operable to engage an interior surface of the mixing core inner shell 311. The mixing core inner shell 311 defines a mixing core chamber 312 accessible to receive a pod. A series of elongated ridges 378 are positioned on the exterior surface of the mixing core inner shell 311. The elongated ridge 378 has a depth away from the surface of the mixing core inner shell 311. The depth increases at a first protrusion 383 and again at a second protrusion 382, so that the depth of the elongated ridge 378 increases from the base to the top of the shell. The elongated ridges 378 which secure the inner shell within the outer shell and provides structural stability for the core. A mixing core outer shell 317 has an interior cavity and is sized to slide over the mixing core inner shell 311. An insertion aperture 318 is provided that receives a pod containing a concentrate during use. A mixing core sealing o-ring 320 is provided that fits within a recess on the outer surface of the mixing core outer shell 317. The mixing core cap 321 engages the mixing core outer shell 317, as better illustrated in the cross-sections shown in FIG. 3H-I.

From the cross-sections shown in FIG. 3H-I, the mixing core cap 321 has an upper exterior facing surface, and an interior facing surface. The interior facing surface also has a left side and a right side which engages a mixing core outer shell 317. A space or interior core cap cavity 322 is created between an interior surface of the mixing core cap 321 and an upper surface of the mixing core outer shell 317. The sides of the mixing core cap 321 nest on a ledge of the mixing core outer shell 317. A downward projection 379 engagingly mates with a corresponding upward projection 380 from the upper surface of the mixing core outer shell 317. The outer side surface of the mixing core outer shell has a recess in which the mixing core sealing o-ring 320 sits. The mixing core inner shell 311 has a mixing core chamber 312, a mixing core chamber needle aperture 314, a mixing core chamber floor 313, a mixing core chamber flush aperture 315 and an autofill hook grappling notch 316. From the side view in FIG. 3I, access to the mixing core chamber 312 is apparent. FIG. 3K is an exterior view of the mixing core inner shell 311, with a plurality of elongated ridges 378, a finger pin aperture 325, with a finger pin 327 and a finger mechanism 326. The finger mechanism 326 nests along the side of the mixing core inner shell 311 and is held in place when the finger pin 327 is pushed into the finger pin aperture 325.

FIG. 3K illustrates the mixing tank column assembly 330. The mixing tank column assembly 330 has a lower column 331 which has a chamber formed therein, an tank upper column 337 which nests within an opening of the lower column 331, and a sealing o-ring 340 that is positioned between the upper column and the outer shell 301 illustrated in, for example, FIG. 3A. FIG. 3L is a cross-sectional view of the mixing tank column assembly 330. From the cross-section shown in FIG. 3L, the push-push mechanism of the mixing tank column assembly 330 has an open-to-closed ridge 335. The indexing pin of the push-push mechanism is both extended and retracted alone by pressing the operating button. The indexing pin does not absorb any axial forces. Rather the indexing pin retracts by spring action and the indexing pin remains free to move during operation. The push-push mechanism provides for a dual push functionality that responds to pushes of different amounts of pressure. For example, a first push of a first pressure, for example a light push, causes the tank core to extend away from the body of the mixing tank 300 to allow for insertion of a pod into the exposed aperture, and a second push of a second pressure, e.g., a deeper push, activates the telescopic needle to pierce the pod and begin filling the tank.

FIG. 3L also illustrates the push-push mechanism finger position at an open state 332, the push-push mechanism finger position at a closed state (e.g., push-push mechanism closed position recess 333), the push-push mechanism finger position at a filling state (push-push mechanism filling state recess 334) and a push-push mechanism filling-to-closed ridge 336.

FIG. 3M is a cross-section of the mixing tank column assembly 330, with the lower column 331 and the tank upper column 337. The sealing o-ring 340 is shown positioned within an exterior recess on the tank upper column 337. The tank upper column 337 also has a first vent hole 339 which allows air to pass from an interior of the tank column assembly 330 to an exterior of the column assembly, and a second vent hole 341. An interior surface of the lower column 331 features a push-push mechanism closed position recess 333 and a push-push mechanism filling state recess 334. While air can pass in both directions through the first vent hole 339, the first vent hole 339 functions to allow movement of air from the exterior of the tank column assembly 330 to the interior of the tank column assembly 330 above the mixing core sealing o-ring as shown in FIGS. 3Q-R.

Turning now to FIG. 3N, an exploded view of the mixing tank lower assembly 350 is provided including a mixing tank outlet connector 306 and an autofill member. The autofill member has an autofill membrane air cavity shell 374, which has a first half and a second half. The autofill membrane air cavity shell 374 has an autofill membrane air cavity opening 375 on an exterior surface. Additionally, the autofill membrane air cavity shell 374 houses a pressure sensing autofill membrane 371, and an autofill membrane inner support 370. An autofill lever membrane attachment 369 is provided inside the autofill member. A tank inlet connector 305 is secured to an opening in the mixing tank base 351 via threads 367. An inlet valve ball 362 is provided that fits with an opening of the mixing tank inlet valve cap 365. The mixing tank base 351 has a structure extending from an upper surface, and an autofill hook 366 and lever axis 368. The lever axis 368 engages the autofill lever membrane attachment 369. A false floor mechanism 352 is provided that fits on the mixing tank base 351. A mixing needle sheath cap 360 is provided with an inlet valve finger 361 on a lower surface. The mixing needle 354 has a series of outlets 356 at a distal end, and inlets 357 at a proximal end. The mixing needle sheath 358 fits over the needle 354. A needle spring 381 is provided that is positioned between the needle 354 and the needle sheath cap 360.

FIGS. 3O-P illustrate a cross section of the mixing tank lower assembly 350 with the needle 354 positioned within the needle sheath 358 and nested within the cavity of the structure extending from the upper surface of the mixing tank base 351. FIG. 3P includes the autofill membrane apparatus.

FIGS. 3Q-Z are cross-sectional views of the mixing tank 300 at different operational times with the upper surface of the mixing core assembly 310 adjacent the upper exterior surface of the outer shell 301 (FIGS. 3Q-R), with the mixing core assembly 310 extended from within the interior of the outer shell 301 and ready to receive a mixing pod (FIGS. 3S-T), with the mixing core assembly 310 pressed into the interior of the outer shell 301 so that the inlet valve is open and the autofill hook 366 snaps into the autofill hook grappling notch 316 (FIGS. 3U-V), with the open inlet valve activating needle activated via water pressure, e.g., water pressure from the plumbing system, to pierce and flush the pod, and with the water in the mixing tank cavity rising to a level of the first vent hole 339 which increases pressure inside the mixing tank cavity 302, pushing the pressure sensing autofill membrane 371 outward and disengaging the autofill hook 366.

FIG. 3U shows the mixing core assembly 310 pressed into the interior of the outer shell 301 so that the needle assembly pierces the mixing pod at a 90 degree orientation from the view in FIG. 3S. FIG. 3T illustrates the upper surface of the mixing core assembly 310 adjacent the upper exterior surface of the outer shell 301 at a 90 degree orientation from the view in FIG. 3Q.

As will be appreciated by reviewing FIGS. 3Q-Z, the functionality of the mixing tank 300 further be appreciated as: a filling sequence, a needle 354 operation, foam minimization, an autofill mechanism, and a two level push-push mechanism. The foam minimization is achieved by sealing the chamber where the pod is pierced to prevent or minimize the amount of available air, thereby reducing any foaming action during the mixing process.

When the user lightly presses downward on the mixing core assembly 310, the up and down motion of the mixing core assembly 310 is driven by a variation of the open/closed push-push mechanism (press and release to open, press back in to close). The push-push mechanism allows for two user gestures (e.g., two user pressures applied) when the core is closed: a shallow push (applying a first pressure), and a deep push (applying a second pressure). Applying a shallow push moves the mixing core assembly 310 between 5 mm and 15 mm into the outer shell 301 when the mixing core assembly 310 is closed (i.e., has an upper surface flush with the outer shell wall) will cause the mixing core assembly 310 to extend upward into an open state. The upward movement can be a “pop.” In contrast, pushing the mixing core assembly 310 deeper than 15 mm (e.g., applying the second pressure) will activate the filling process. The mechanism is designed so that a user can lower the mixing core assembly 310 all the way to a deep push in a single motion.

The up and down motion of the mixing core assembly 310 is driven by a variation of the open/closed push-push mechanism (press and release to open, press back in to close). Once the mixing core assembly 310 is in an open configuration (e.g., after a shallow push), the user inserts a pod into the mixing core chamber 312, which is now accessible, as shown in FIG. 3R. Once the pod is inserted into the mixing core chamber 312, the users pushes the mixing core assembly 310 all the way down (with a deep push), which opens the mixing tank inlet valve (having the mixing inlet valve finger 361, the inlet valve ball 362 of the mixing valve, the mixing tank inlet valve cavity 363, the inlet valve throat 364 of the mixing tank, and the inlet valve cap 365 of the mixing tank). The resulting water pressure causes the needle 354 to move upward and pierce the pod. The content of the pod is then flushed via small openings at the needle outlets 356 of the needle 354, The resulting solution escapes down from the mixing chamber via core chamber flush aperture 315 and then fills the tank cavity 302. An autofill hook 366 secures the mixing core in place during the filling state. Once the mixing tank is full, the mixing tank uses a pressure sensing autofill membrane 371 to release the autofill hook 366, which allows the mixing core assembly 310 to pop back into the closed state, and the filling process stops.

During the filling operation, the needle 354 uses the force of home water pressure to pierce the pod. The needle 354 is configured to freely move up and down inside the mixing needle sheath 358. At rest, the inlet valve ball 362 is pushed against the inlet valve throat 364 by water pressure, which shuts down the valve.

Pressing down on the mixing core assembly 310 presses down on the needle sheath 358 which moves down the inlet valve finger 361, thereby forcing the inlet valve ball in a downward direct to opens the valve. As will be appreciated by those skilled in the art, the water pressure immediately accumulates below the needle. Additionally, the section of the needle sheath 358 below the narrowing 359 is relatively tight, consequently the water has nowhere to go and exerts significant upward force on the bottom of the needle 354, resulting in a projectile action that causes the needle 354 to shoot upward towards the pod. The portion of the sheath above the narrowing is slightly wider. As the needle moves upward and pierces the pod, the wider upper cavity allows water to move around the needle, enter the inlets 357 positioned towards a base of the on the side the needle 354 and shoot out via the needle outlets 356 positioned at the tip of the needle 354, flushing the pod and filling the tank. At the end of the filling cycle, gravity returns the needle back to the bottom of the sheath (aided by the metallic weight).

The operation of the system is also configured to minimize foaming. As will be appreciated by those skilled in the art, flushing concentrated surfactant with water at high velocity normally creates a large amount of foam due to the presence of air. To prevent foaming, the mixing core chamber 312 is sealed from outside air. The seal is created by mixing core sealing o-ring 320 pressing against the column constriction 338. Because of the seal, air is quickly evacuated from the column from the bottom and the second vent hole 341 (e.g., secondary column vent hole), and eventually escapes the tank via a first vent hole 339 near the top of the visible tank cavity 302. The hole connects to the inside of the tank upper column 337 which is above the seal and connects with the outside.

Another feature of the operation is an autofill mechanism. As will be appreciated by those skilled in the art, a toilet flush tank autofill mechanisms uses either floaters or a water column membrane, these mechanisms are not precise enough achieve a precise fill level on a smaller scale. The autofil system is also configured to seal the tank cavity from ambient air except for a small amount of air provided through the small vent aperture. The autofill mechanism achieved with the disclosed mixing tank 300, relies on the principle that liquids have a much harder time squeezing through a small hole than gas. When the user presses down on the mixing core and activates the filling state described above, the autofill hook 366 snaps into the autofill hook grappling notch 316 and locks the core in the filling position. As the tank fills, the tank cavity is mostly sealed, as noted to achieve foam minimization, and the air escapes entirely via a first vent hole 339 (small vent hole) at the top of the mixing tank. However, once the solution level in the mixing tank reaches the level of the first vent hole 339, the solution tries to squeeze through the first vent hole 339. Because the first vent hole 339 is sized for air (e.g., smaller), fluid has a much harder time escaping via the vent hole, which considerably increases the pressure inside the mixing tank within a fraction of a second. The sudden increase in pressure pushes the pressure sensing autofill membrane 371 outward, which moves the autofill hook via a lever and releases the mixing core assembly 310. The mixing core spring 304 then moves the core up to the closed state, which immediately stops the filling and unseals the tank as the core sealing o-ring 320 moves up. Because there is a small amount of foam on top of the solution as the tank fills, some of the foam has the time to squeeze through the vent hole before the core gets released. To prevent foam from accumulating around the core cap 321, the core cap has a lower opening 323 facing the exit of the first vent hole 339 that allows foam to accumulate into the interior core cap cavity 322. Once the filling cycle is over, content of the core cap cavity slowly drips the fluid back into the mixing tank.

### IV. Base Station

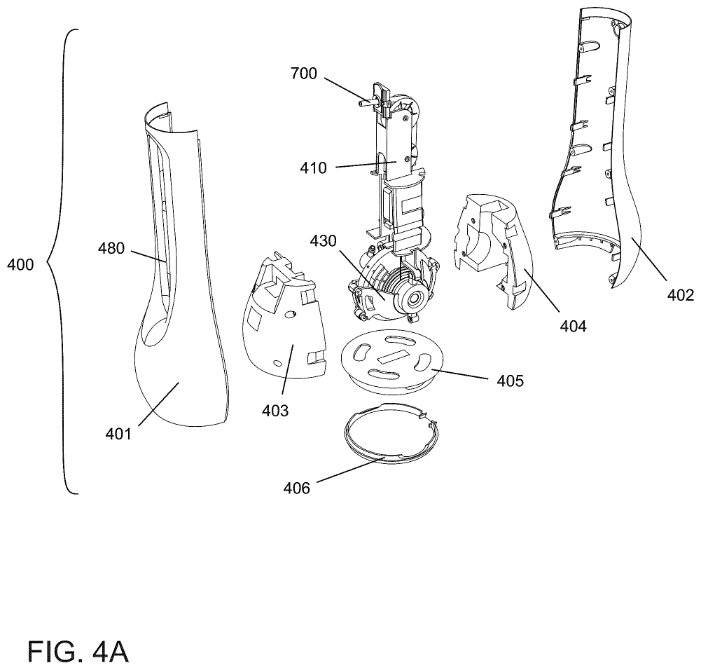

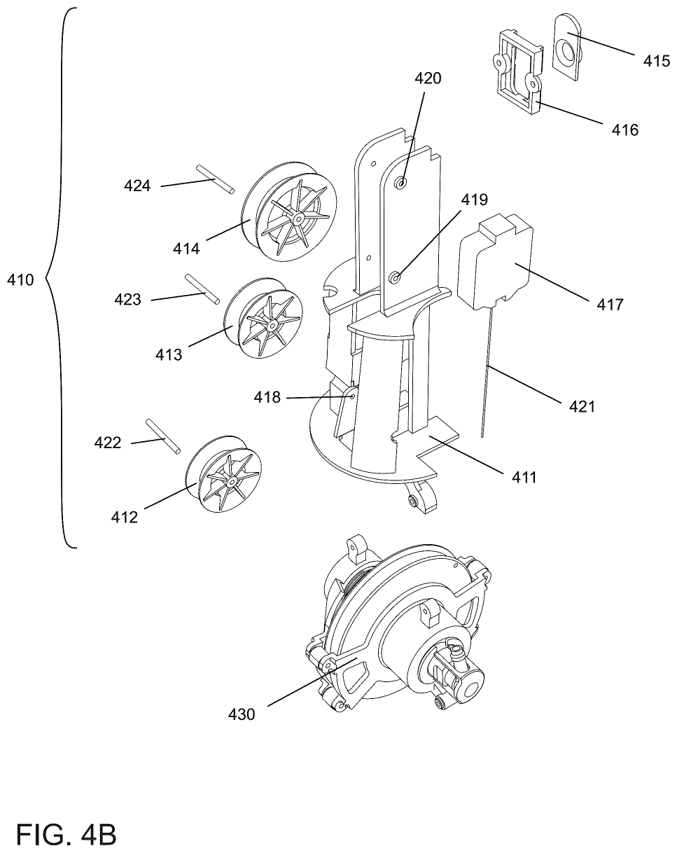

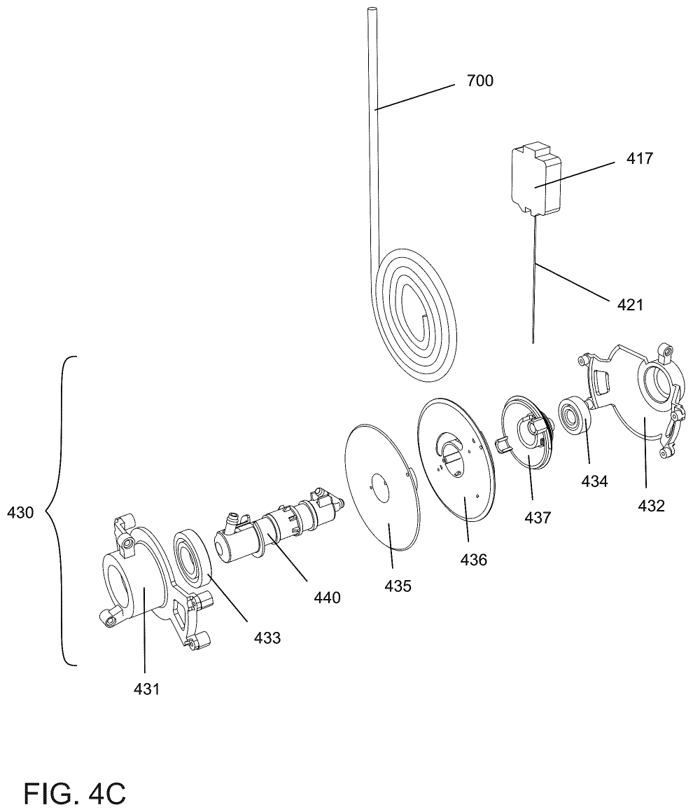

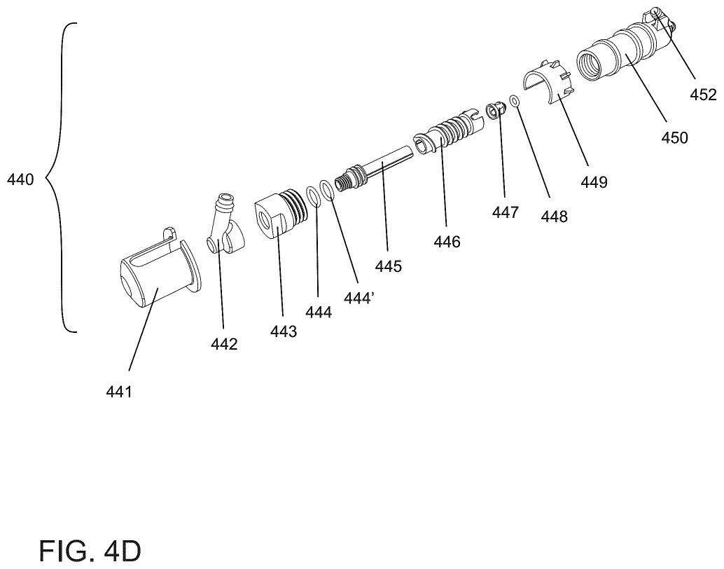

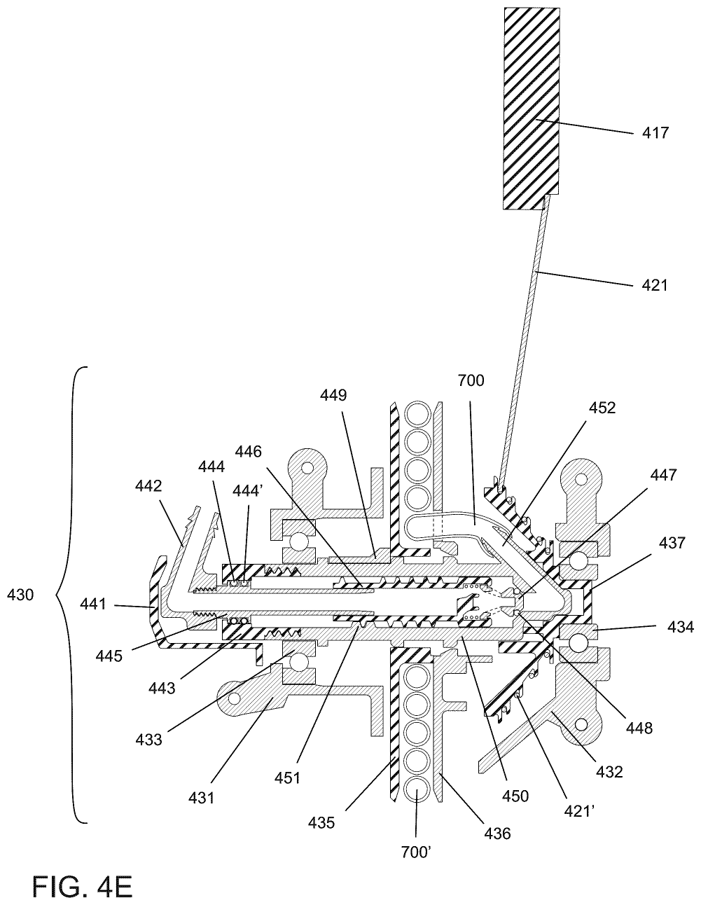

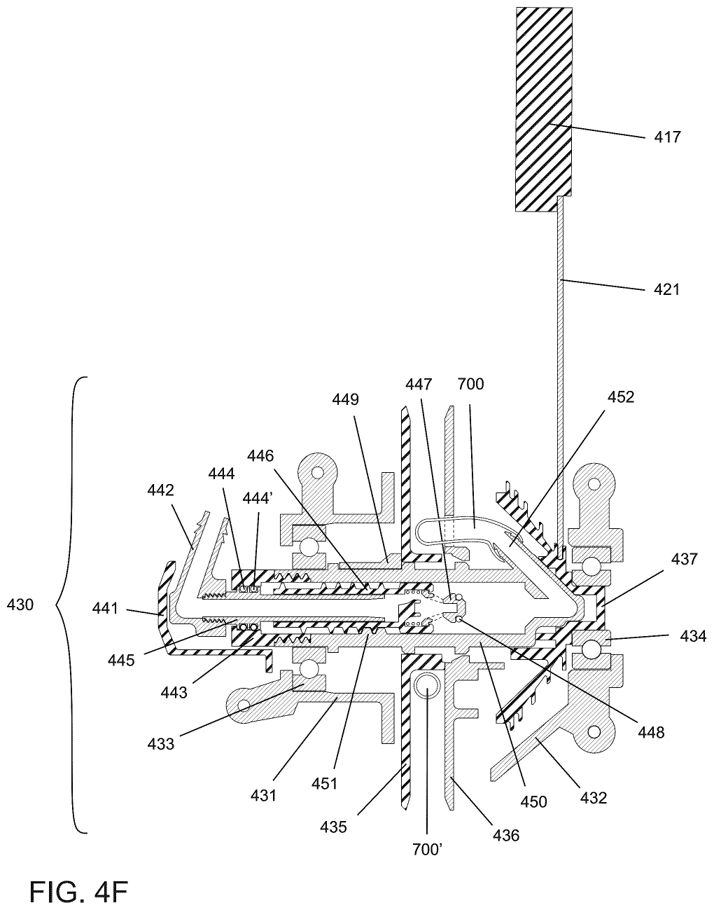

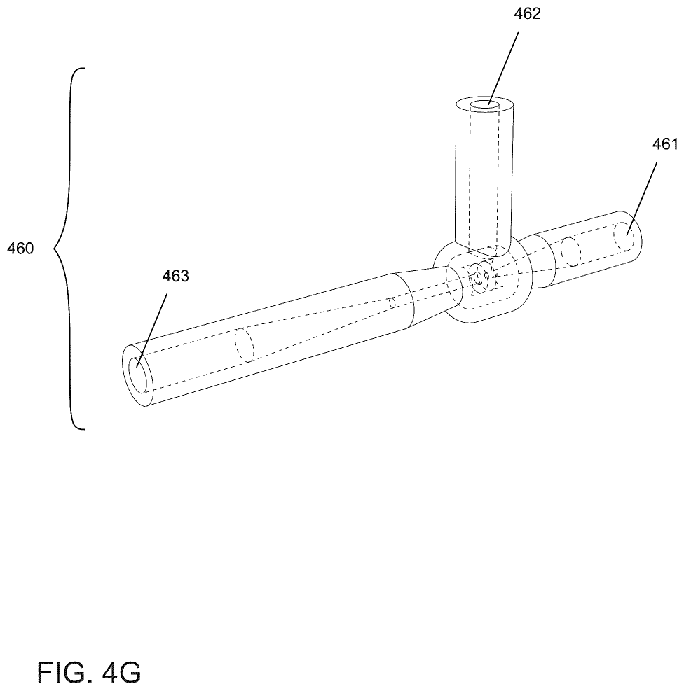

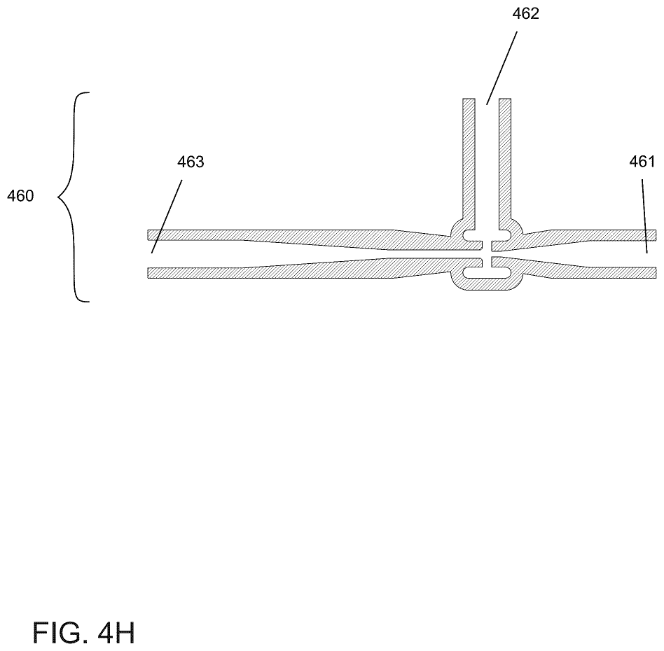

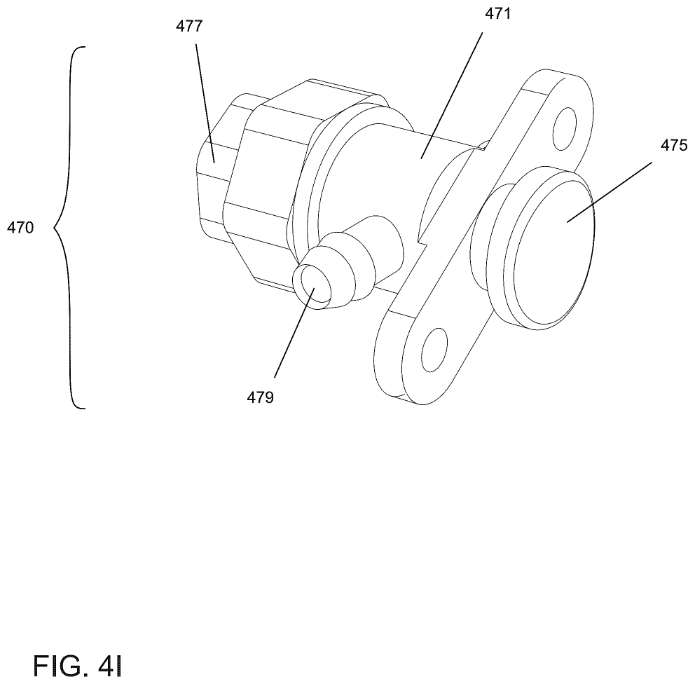

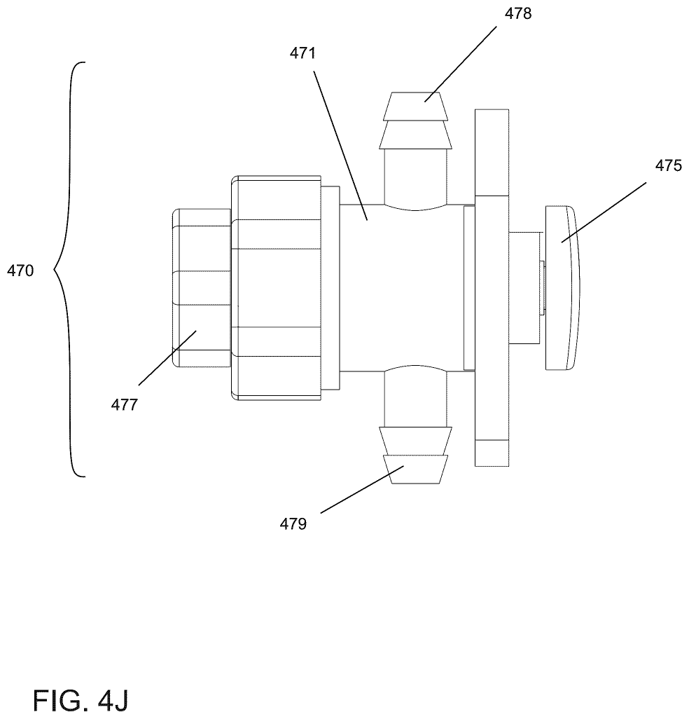

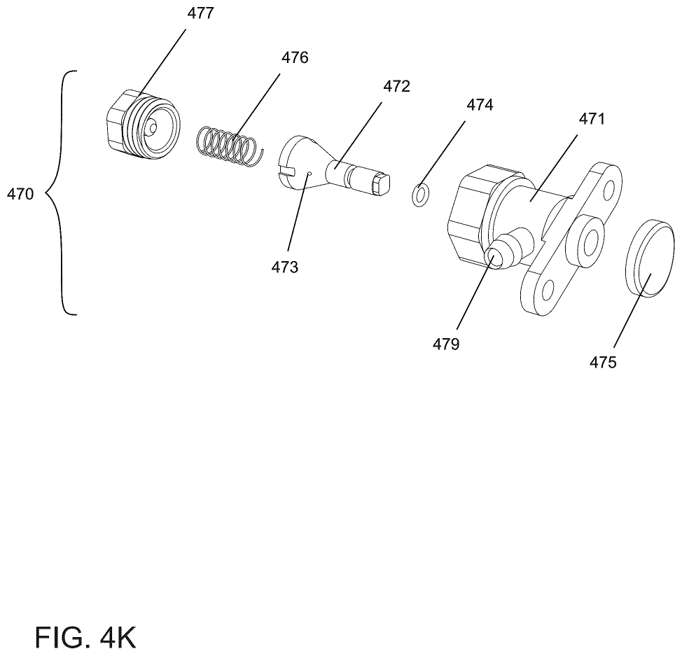

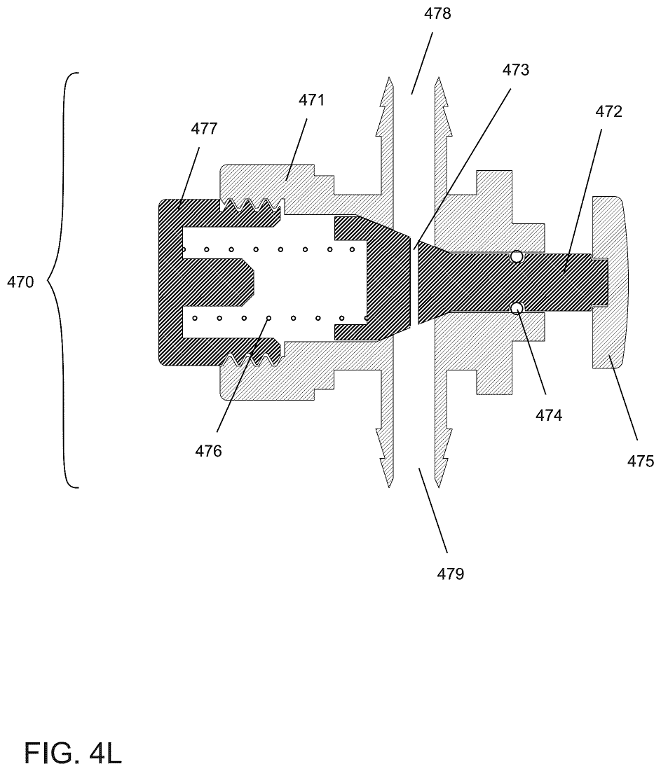

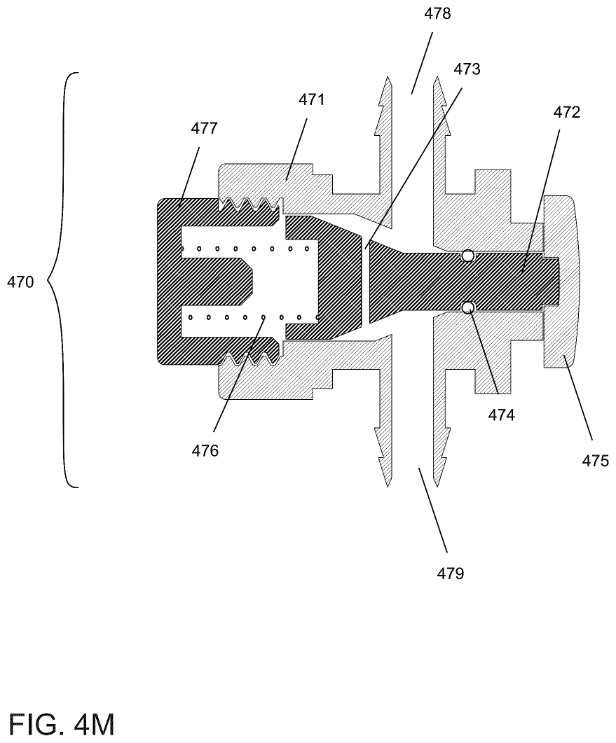

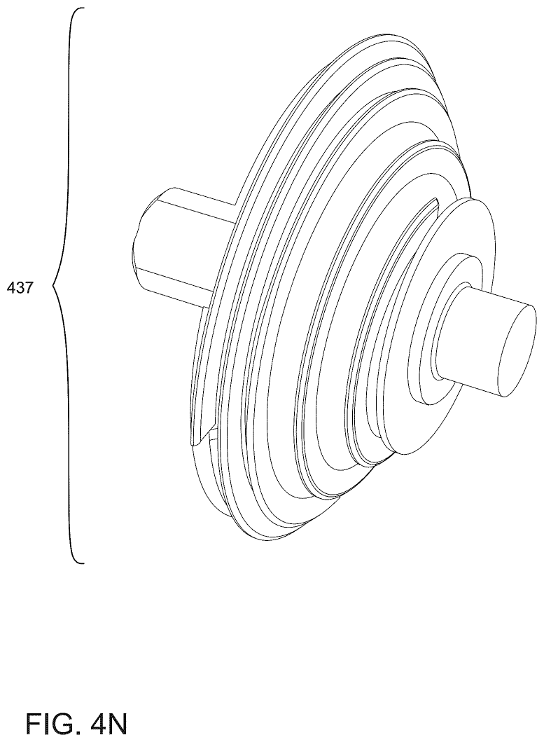

The base 400 of the device is illustrated in FIGS. 4A-O. The base 400 has a base housing. The housing can have a front housing 401 and a back housing 402. The base housing has a lower end with a wider circumference than an upper end, such that the housing, as illustrated, has a bottle-like shape which tapers from bottom to top. A surface of the housing further includes a recess 480 configured to receive the fluid applicator wand 200 shown in FIG. 2. The fluid applicator has a fluid applicator wand body with a front surface and a rear surface. A ballast having a front ballast 403 and a rear ballast 404 fits within an interior cavity of the housing at its lower end. An inlet hose compartment 405 is provided which engages the base bottom cover 406. A reel assembly 430 is provided that allows the fluid carrying tubing 700 to wrap around the assembly when the wand is in an un-deployed configuration. The reel assembly 430 (FIG. 4C) operates with the pulley assembly 410.

FIG. 4B is a partially exploded view of the pulley assembly 410 with the reel assembly 430 (shown exploded in FIG. 4C). The pulley assembly 410 has a pulley mount 411 which engages a plurality of pulleys, first pulley 412, second pulley 413, third pulley 414, wherein each pulley has a groove operable to engage the fluid carrying tube (e.g., hose), and further wherein each pulley has a different diameter. The pulley assembly 410 changes the force required to withdraw the wand from the hygiene base and facilitates ensuring the wand is returned to an undeployed position after use. The first pulley 412 fits within a channel of the pulley assembly housing and aligns with a lower pulley axis 418. The second pulley 413 fits within a channel of the pulley assembly housing and aligns with a middle pulley axis 419. The third pulley 414 fits within a channel of the pulley assembly housing and aligns with an upper pulley axis 420. Each pulley axis is mounted to the pulley assembly housing at the axis via, for example, a pin rod 422, 423, 424. An outlet hose retractor 417 is provided with an elongated retractor cable 421 extending from a surface. The outlet hose retractor 417 is positioned within a channel of the pulley assembly housing. Additionally, an exit slider 415 and exit slider mount 416 is provided that engages the pulley assembly housing.

FIG. 4C is an exploded view of the reel assembly 430. The reel assembly 430 has a first housing mount 431 and a second housing mount 432. Between the housing mounts is a first bearing 433 which engages a reel valve assembly 440 on a first end. The reel valve assembly 440 passes through an aperture in a reel cover 435, a reel plate 436, and a retractor cable spiral 437 before engaging a second bearing 434. The second bearing 434 nests within a circular recess in the second housing mount 432. FIG. 4D provides an exploded view of the reel valve assembly 440. The reel valve assembly 440 has a valve holder 441 with an elongated slot on an exterior surface and recess configured to receive a reel valve inlet 442. The reel valve inlet 442, has an inlet member that extends from a surface of the reel valve inlet 442 to pass through the elongated slot when the reel valve inlet 442 is positioned within the valve holder 441 recess. A valve housing cap 443 is provided that secures the reel valve inlet 442 within the valve holder 441. Two outlet hose reel valve nipple o-rings 444, 444′ are provided that fit within an opening of the valve housing cap 443. A valve nipple 445 has a first threaded end that passes through the aperture of the valve housing cap 443, to threadedly engage the reel valve inlet 442. The outlet hose reel valve nipple o-rings 444, 444′ prevent the valve nipple 445 from overtightening and also provides a sealing function. A valve shuttle 446 is positionable over the valve nipple 445. The valve nipple 445 has external threads at its reel valve inlet 442 engaging surface. Two recesses are formed into which the outlet hose reel valve nipple o-rings 444, 444′ are position. The remainder of the valve nipple 445 has a smooth exterior surface. The valve shuttle 446 slides over the smooth exterior surface of the valve nipple 445 until it abuts the second set of external threads. A valve plug 447 rests within an aperture of the valve shuttle 446. A valve plug o-ring 448 nests against the valve plug 447. The assembly fits within an aperture in a reel valve housing 450. A reel spacer 449 having a semi-circular cross-section fits over the exterior of the reel valve housing 450. An outlet hose reel valve outlet 452 is at a first end of the reel valve housing 450. The reel valve also turns off water pressure from the wand when the wand is fully retracted.

FIGS. 4E-F illustrates a cross-section of the reel assembly 430 with all the components engaged. In FIG. 4E, the valve plug 447 is adjacent opening of the reel valve housing 450 to block fluid flow. In FIG. 4F, the valve plug 447 is positioned away from the opening of the reel valve housing 450. The outlet hose retractor 417 and retractor cable 421, are shown engaging the retractor cable spiral 437. As a user pulls the hose out, the reel valve housing 450 rotates. The housing has a slot 451 that is engaged n a thread around the valve shuttle 446. Because the valve shuttle cannot rotate, the rotation of the valve body engages the shuttle thread and moves the shuttle to the left (as shown in the figure). This movement causes the valve plug 447 to move to the left as well, thereby opening the valve. Because the valve shuttle thread is not uniform along its length, most of the opening of the valve occurs with the first turn of the reel. Consequently, the valve is fully open even if a user only pulls the wand (shown in FIG. 2), 25 cm away from the base.

FIGS. 4G-H illustrate the venturi injector 460. The venturi injector 460 has a housing with a first injector inlet 461, a second injector inlet 462 and an injector outlet 463. From the cross section in FIG. 4H, the tapering of the diameter of the venturi injector at the point where the second injector inlet 462 is positioned can be appreciated. As will be appreciated by those skilled in the art, the venturi injector causes low pressure of a fluid flow at an inlet port. This allows a low pressure to be generated from a high pressure flow. The venturi injector includes a pressure inlet, a suction inlet, an outlet and convergent-divergent constriction within the interior of the injector.

Turning now to FIGS. 4I-L, the solution control valve 470 is illustrated. FIG. 4I is a perspective view of the exterior of the solution control valve 470. The solution control valve 470 has a solution control valve body 471 with a solution control valve outlet 479 extending from the body. A solution control valve cap 475 or button is positioned at a first end of the valve body and a solution control valve cap 477 is positioned at the second end of the valve body. From the side view shown in FIG. 4J, both the solution control valve inlet 478 and solution control valve outlet 479 are visible. The solution control valve inlet 478 and solution control valve outlet 479 are positioned on opposite sides of the solution control valve body 471. The solution control valve 470 regulates the air injection system, e.g., two check valves (control valve and venturi injector) to provide a stable rate of injection of concentrate regardless of the final aperture size of the delivery stream utilized by the wand (e.g., regardless of the position of the wand trigger during use). The user can also increase the injection rate of the liquid into the treat and flush the tank of contents. The air and liquid injection system is a two valve system. Air and liquid are injected through the same pipeline. Air injection acts as a regulatory. The air check valve has precise resistant to air. Even though the valve is flat, there is a change in back pressure. The small change in back pressure changes how much the venturi injector can take. The amount of liquid that comes in remains the same.

From the exploded view of the solution control valve 470, shown in FIG. 4K, the relationship between the components can be appreciated. The solution control valve cap 477 has an exterior surface with a plurality of flat surfaces to aid in gripping the solution control valve cap 475. A portion of the solution control valve cap 477 has threads, additionally the solution control valve cap 477 has an interior cavity with an extension configured to engage a solution control valve spring 476. The solution control valve spring 476 engages the interior of the solution control valve cap 477 at a first end and an interior of a solution control valve plug 472 at a second end. The solution control valve plug 472 has a conical section with a solution control valve plug hole 473, and a tubular section. The conical section of the solution control valve plug 472 is positioned adjacent the solution control valve spring 476. A solution control valve plug o-ring 474 engages the solution control valve plug 472 at its tubular end. The solution control valve body 471 with a solution control valve cap 475 at a first end, receives the solution control valve plug 472 at its second end when the solution control valve is assembled. The cross-section of the solution control valve 470 illustrates the assembled components in FIG. 4L. As appreciated from FIG. 4M moving the solution control valve cap 475 can align the solution control valve plug hole 473 with the solution control valve inlet 478 and solution control valve outlet 479 to allow fluid communication between the inlet and outlet, or position the solution control valve plug hole 473 so that the inlet or outlet are in greater fluid communication because the liquid does not need to pass through the solution control valve plug hole 473. FIGS. 4N-O are exterior views of the retractor cable spiral 437 which reels in the cable. The shape of the retractor spiral provides for a uniform and finely tuned pull-back mechanism. As the cable goes around the narrower section of the spiral, the pull-back momentum of the reel decreases which counteracts the fact that the hose reel is getting smaller (which itself increases perceived pull-back force of the hose). This complementary operation allows the pull-back force to be further reduced so that the pull-back force is lower when the hose is pulled far away from the base than when the hose is closer to the base. Letting go of a fully extended wand will result in the wand, slowly retracting towards the base before being pulled into a docking position.

### V. HUB

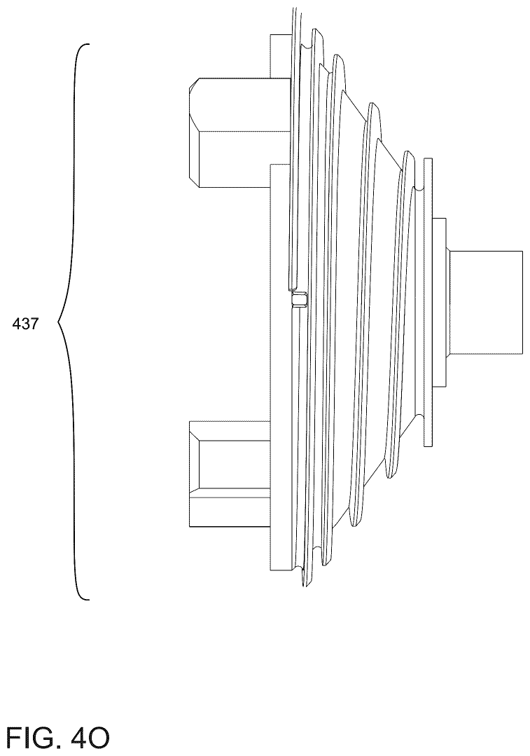

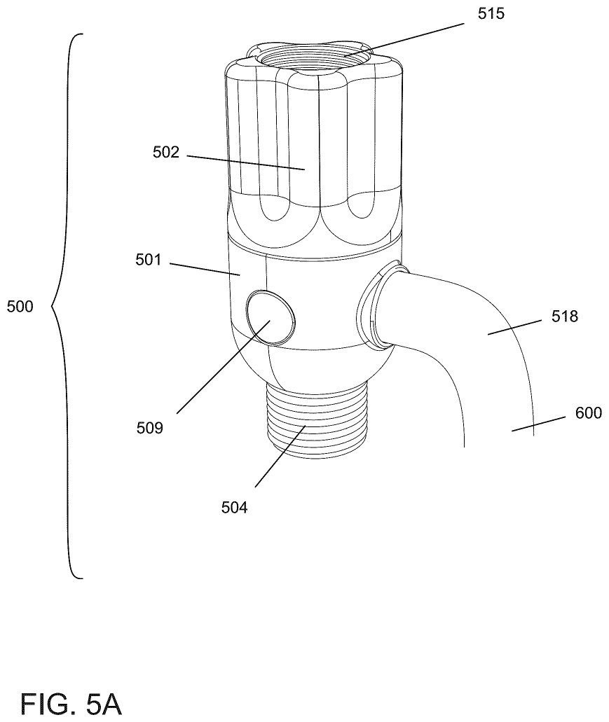

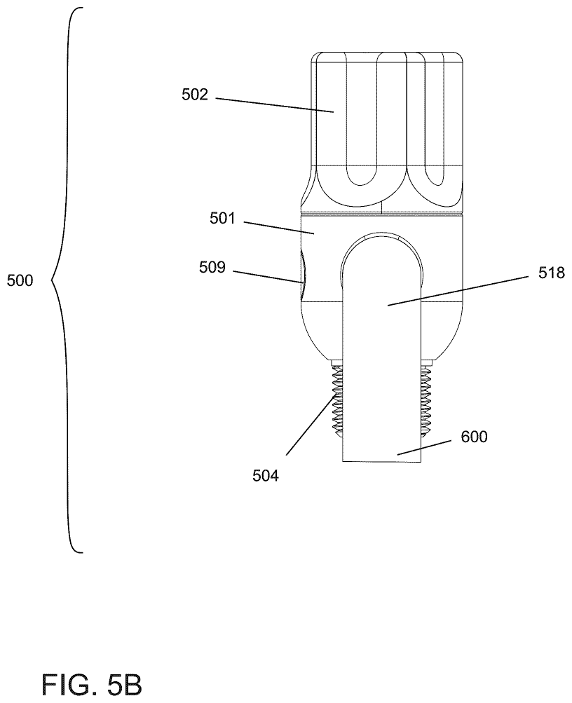

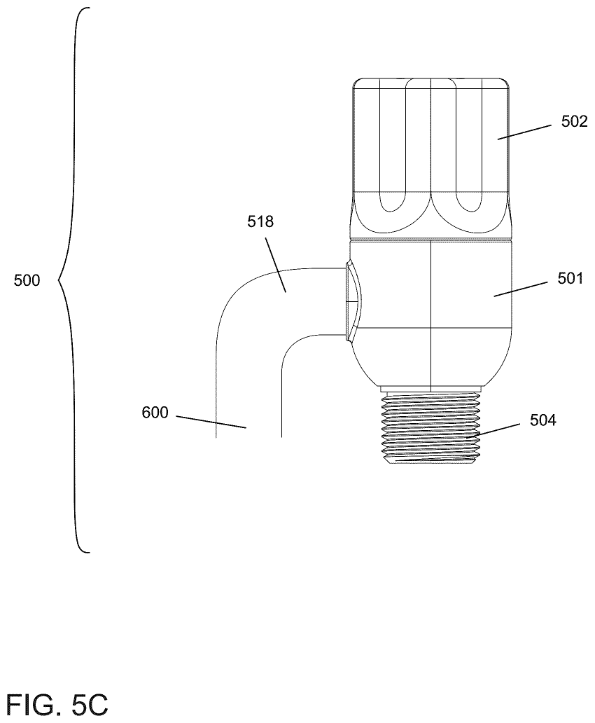

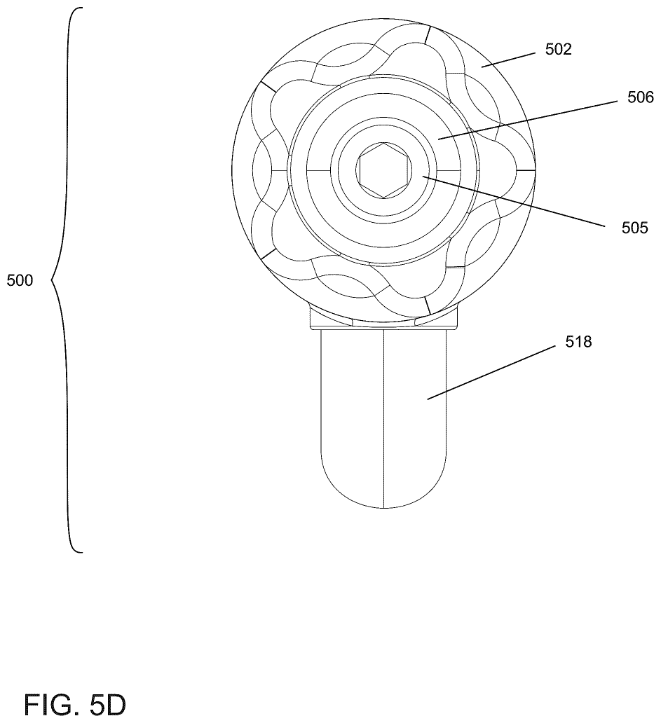

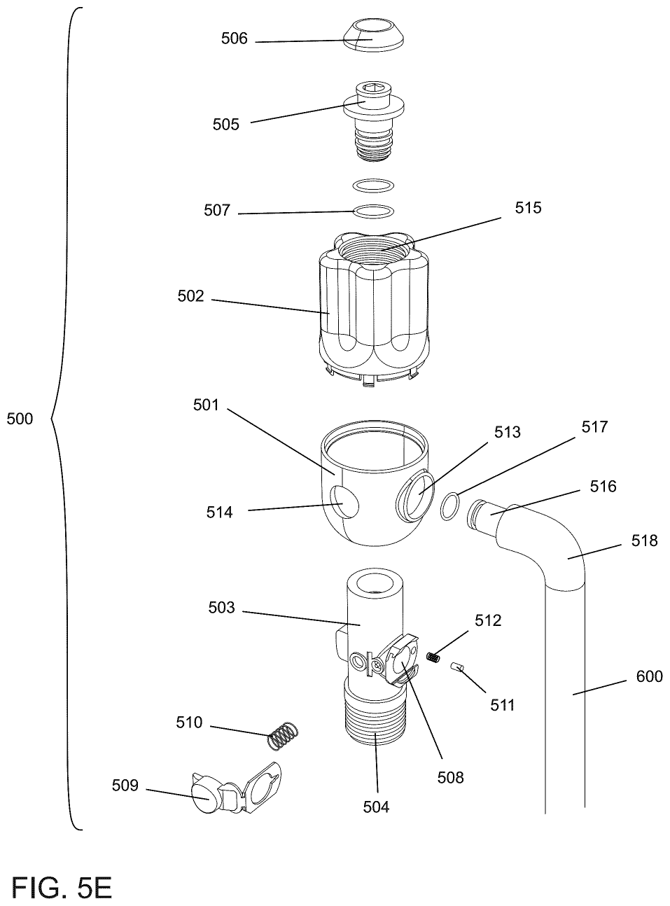

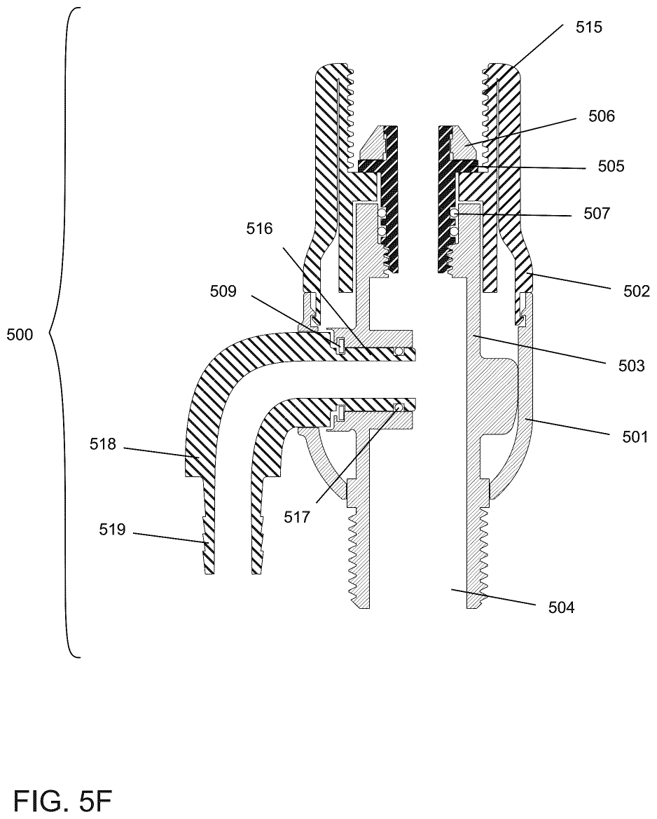

The hub 500 is illustrated in FIGS. 5A-5F. FIGS. 5A-D are exterior views of the hub 500 from different perspectives. The hub provides for easy ergonomic installation of the system and connection to the water system. The hub 500 has a first hub housing 501 that engages a second hub housing 502. The first hub housing 501 has a push connector release button 509 on a side surface, and a threaded hub water inlet 504 configured to access an external water supply, such as a home plumbing system. The first hub housing 501 also has a hub elbow connector 518 that connects the hub to the hygiene system (as illustrated in FIG. 1) via an inlet hose 600. The second hub housing 502 has an internally interior threads 515 that is configured to connect the hub to the toilet tank 70 (in FIG. 1A). FIG. 5B is a back view of the hub 500. FIG. 5C is a side view of the hub 500, and FIG. 5D is a view of the hub from the second hub housing 502 side.

FIG. 5E is an exploded view of the hub 500 and FIG. 5E is a cross-section of an assembled hub 500. The inlet hose 600 is connected to the first hub housing 501 via a hub elbow connector 518 which has a male push connector 516 configured to engage a hub push connector outlet 513 on the side of the first hub housing 501. A connector o-ring 517 is provided which seats within a recess on the male push connector 516. The lower housing also has a connector release button housing opening 514 which is positioned about 90 degrees from the hub push connector outlet 513 and in substantially the same plane. Other locations could be used without departing from the scope of the disclosure. The first hub housing 501 receives a hub inner core 503 through an aperture on the lower surface of the first hub housing 501 (the aperture is apparent from the cross-section in FIG. 5F). The hub inner core 503 is substantially tubular in shape with has a threaded end of the hub water inlet 504 which functions as an inlet from a water supply. The side of the hub inner core 503 has a push connector outlet 508 which includes a release holding pin 511 and a release button holding pin spring 512. A flange extends from a side of the hub inner core 503 opposite the location of the push connector outlet 508. A hub push connector release button 509 and release button spring 510 is provided which accesses the interior of the first hub housing 501 via the push connector release button housing opening 514. The first hub housing 501 engages a second hub housing 502 at its upper end. The second hub housing 502 forms a cavity within the second hub housing 502. The lower end of the upper hub housing 502 has a series of flanges which provide a snap fit arrangement with an interior raised lip of the first hub housing 501. The snap fit arrangement allows the second hub housing 502 to freely rotate around the rest of the assembly. The upper end of the upper hub housing 502 has an opening with interior threads 515 The connector seal 506 engages an upper surface of a hub outlet 505 and seats against a hub outlet lip that extends from a side surface of the hub outlet 505. The lower end of the hub outlet 505 is threaded and engages two water outlet o-rings 507. The connector seal 506 and hub outlet 505 fit within the upper aperture of the second hub housing 502.

As will be appreciated by those skilled in the art, a difficulty encountered when screwing a t-connection below the toilet tank is cross-threading as the toilet tank inlet is in a difficult to reach location and generally out of sight of a kneeling user. At time of install, the hub is separated from the inlet hose 600 and elbow connector 516, and is hence the first hub housing 501 and the second hub housing 502 have a simple cylindrical shape that is easy to hold in the palm of the user's hand. The user can then screw the second hub housing 502 into the toilet tank 70 by turning the second hub housing 502 with their hands. Once hub 500 is secured to the toilet tank 70, the user can then screw water supply onto hub water inlet 504, and snap hub elbow connector 518 into the male push connector 516.

### VI. Pods and Pod Concentrates

A concentrated solution is provided for use with the hygiene system. The concentrate has one or more of fragrance and a cleaning solution. The pod formulation can also be buffered and PH balanced. Additionally, anti-bacterial, anti-yeast and other components can be included (e.g., mandelic acid, lactic acid and sorbic acid). The concentrate is a liquid encapsulated in an a polyvinyl alcohol (PVOH) sheath, such as concentrate pod 110 shown in FIG. 1K. The encapsulation sheath is biodegradable. The pod shape can be spherical or a flattened spherical shape or flattened sphere, or sphere. The formulation of the concentrate achieves a pH balance after dilution in water of 500× to 700×. The formulation is selected to maintain a pH between 3.8 and 5.5 with a neutral (soft) water or an alkaline (hard water). The formulation can buffer in most situations. Formulations also include lactic acid, sodium diacetate, potassium sorbate, and mandelic acid. An aspect of the formulation is that the formulation maintains PH balance when in a diluted state.

The concentrated solution in the pod can be formulated to contains on or more of: sorbic acid (2,4-hexadienoic acid), acetic acid (CH₃COOH), Witch Hazel (derived from the Hamamelis virginiana shrub), Zinc Oxide (ZnO), calamine (zinc oxide and 0.5% ferric oxide (Fe₂O₃)), phenylephrine (C₉H₁₃NO₂), epinephrine (C₉H₁₃NO₃), pramoxine (C₁₇H₂₈ClNO₃), benzocaine (C₉H₁₁NO₂), dibucaine (C₂₀H₂₉N₃O), lidocaine (C₁₄H₂₂N₂O), dyclonine (C₁₈H₂₇NO₂), tetracaine (C₁₅H₂₄N₂O₂), benzyl alcohol (C₇H₈O), resorcinol (C₆H₆O₂), clotrimazole (C₂₂H₁₇ClN₂), miconazole (C₁₈H₁₄Cl₄N₂O), terconazole (C₂₆H₃₁C₁₂N₅O₃), tioconazole (C₁₆H₁₃C₁₃N₂OS), clindamycin (C₁₈H₃₃ClN₂O₅S), benzydamine (C₁₉H₂₃N₃O), boric acid (H₃BO₃), Vitamin C (C₆H₈O₆), ibuprofen (C₁₃H₁₈O₂), isobutanol ammonium (C₄H₁₄NO), Triticum vulgare extract, hydrocortisone (C₂₁H₃₀O₅), and nystatin (C₄₇H₇₅NO₁₇). These compounds are intended to be exemplar and not exhaustive as useful for treating, for example, compounds for treating one or more of hemorrhoids, anus pruritus, bacterial vaginosis, urinary tract infections, post-partum vaginal care, and diaper rash.

Additionally, one or more topical agents (either over-the-counter (OTC) or prescription) can be added to the pod formulations. For example, agents or compounds useful for addressing hemorrhoids or anus pruritus, such as: post-biotics/Organic Acids (e.g. Lactic Acid, Mandelic Acid, Sorbic Acid, Acetic Acid), hydrocortisone, astringents (e.g., Witch Hazel, Zinc Oxide, Calamine, vasoconstrictors (e.g., Phenylephrine, Epinephrine), and local Anesthetics (e.g. Pramoxine, Benzocaine, Dibucaine, Lidocaine, Dyclonine, Tetracaine, Benzyl Alcohol, Resorcinol). In another formulation, agents or compounds useful for addressing bacterial vaginosis can be added to the pod formulations. For example, post-biotics/Organic Acids (e.g., Lactic Acid, Mandelic Acid, Sorbic Acid, Acetic Acid), antifungals (e.g. Clotrimazole, Miconazole, Terconazole, Tioconazole), antibiotics (e.g., Clindamycin), anti-inflammatory (e.g., benzydamine), hydrocortisone, local Anesthetics/anti-itch compound (eg Pramoxine, Benzocaine, Dibucaine, Lidocaine, Dyclonine, Tetracaine, Benzyl Alcohol, Resorcinol), boric Acid, Vitamin C, Ibuprofen Isobutanolammonium, and Triticum vulgare extract. In yet another formulation, agents or compounds useful for addressing recurrent urinary tract infections (UTIs) can be added to the pod formulations. For example, Post-biotics/Organic Acids (e.g., Lactic Acid, Mandelic Acid, Sorbic Acid, Acetic Acid). In still another formulation, agents or compounds useful for addressing post-partum vaginal care can be added to the pod formulations. For example, Post-biotics/Organic Acids (e.g., Lactic Acid, Mandelic Acid, Sorbic Acid, Acetic Acid), Witch Hazel, Hydrocortisone, and local anesthetics/anti-itch (e.g., Pramoxine, Benzocaine, Dibucaine, Lidocaine, Dyclonine, Tetracaine, Benzyl Alcohol, Resorcinol). In another formulation, agents or compounds useful for addressing diaper rash can be added to the pod formulations. For example, post-biotics/Organic Acids (e.g., Lactic Acid, Mandelic Acid, Sorbic Acid, Acetic Acid), Zinc Oxide, Witch Hazel, Antifungal (e.g., nystatin, clotrimazole), and Hydrocortisone.

An exemplar pod concentrate formula is in Table 1.

TABLE 1

| Ingredient | CAS | % Fragrant Base |
|---|---|---|
| HiPure 90 Lactic Acid | 50-21-5 | 10.00% |
| Mandelic Acid | 90-64-2 | 8.00% |
| Sodium Diacetate | 126-96-5 | 10.00% |
| Potassium Sorbate | 24634-61-5 | 2.50% |
| Polysorbate 20 | 361459-38-3 | 54.55% |
| Fragrance | | 14.95% |

### VII. Method of Use

### A. Preparing the Hygiene System for Use

Turning back to FIG. 1J, the mixing tank 300 receives a concentrate pod into the mixing chamber, the needle punctures the pod in the mixing chamber and flushes the pod content with water, to dilute the concentrate into solution before releasing the solution into the mixing tank.

The base 400 is connected to a water supply which has a hub positioned between the water supply and the toilet tank. The hub delivers water through a pressure regulator 492 that is connected to a backflow preventer 493. Fluid passes from the backflow preventer to the venturi injector, reel valve and then into the fluid applicator wand 200. The wand delivers fluid by a first nozzle, a second nozzle or both the first and second nozzle in response to the pressure applied to the wand actuator 205. Fluid also passes from the backflow preventer to the tank inlet valve of the mixing tank 300 and then into the mixing chamber (which has received the concentrate pod) and into the solution tank. Fluid then passes from the solution tank to the solution control valve into the injection check valve 490, the venturi injector and reel valve before being received by the wand. Ambient air is received into an aeration check valve 491 which is added to the stream from the solution tank between the solution control valve and the injection check valve.

By acting as a vacuum moderator, the aeration check valve 491 ensures a constant and precise level of vacuum between the solution control valve and the injection check valve, which ensures a constant and precise rate of solution passing through the solution control valve and being injected into the wand stream.

### B. Device Usage

The double nozzle configuration of the fluid applicator wand 200 allows the fluid flow to exit the fluid applicator wand 200 in at least a first perceived pressure and a second perceived pressure. Due to the configuration of the piston valve rod 229 when pressure is applied to the actuator by the user, thus drawing the actuator in a distal direction, fluid comes out of the washing wand at a first perceived pressure. The perceived pressure of the fluid becomes more intense and focused as the user continues to press down on the actuator, taking the perceived fluid pressure from a soft mode to a hard mode. This change in perceived pressure operates on a continuum from a first starting perceived pressure to a second final perceived pressure, greater than the first perceived pressure, with discrete perceived pressure changes in between. The user can choose to maintain a delivered perceived pressure at any point between the starting perceived pressure and the final perceived pressure as desired, i.e., the actuator does not need to be fully withdrawn in a distal most position during use.

Because of the double nozzle configuration, notwithstanding the change in perceived pressure, the total flow in liters per minute stays relatively constant as the user actuates the device. Thus a relatively constant flow is maintained which optimizes operation of the venturi injection system.

If the user wishes to empty the mixing tank of its content, e.g., before using all the contents, the user can press the solution control valve cap 475 at the back of the base 400 while spraying the wand into the toilet bowl. This opens the solution control valve, which greatly increase the rate of injection of solution into the wand stream, which allows to empty the content of the tank.

### XII. Kits

The disclosed personal hygiene washing systems can be provided as a kit. The can include one or more of: a fluid applicator wand 200, described in more detail in FIGS. 2A-K above; a mixing tank 300, described in more detail in FIGS. 3A-U above; a base 400, described in more detail in FIGS. 4A-O above, a hub as described in more detail in FIGS. 5A-F; and/or pods containing a concentrated fluid as discussed in Section VI above. An installation tool can also be provided with the kits.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

1. A hygiene washing system comprising:
a base;
a mixing tank comprising an outer shell, a tank column assembly positioned within the outer shell, a mixing core which engages the tank column assembly, a lower tank assembly with a mixing needle wherein the mixing tank comprises a solution control valve operable to regulate an air injection system; and
a retractable fluid applicator wand.

2. The hygiene washing system of claim 1 wherein the retractable fluid applicator wand has a fluid applicator wand body with an elongated central housing aperture with a wand actuator at a first end of the elongated central housing aperture, and a pair of adjacent fluid delivery apertures comprising a first fluid delivery aperture and a second fluid delivery aperture.

3. The hygiene washing system of claim 2 wherein the first fluid delivery aperture and the second fluid delivery aperture have an aperture shape selected from round, oval, ovoid, square, rectangular, and triangular.

4. The hygiene washing system of claim 1 further comprising a piston valve.

5. The hygiene washing system of claim 4 wherein the piston valve further comprises a lower piston housing chamber with an opening sized to receive an upper piston valve housing, and a piston valve ball positioned between a lower piston housing and an upper piston ball housing.

6. The hygiene washing system of claim 5 wherein the piston valve further comprises a moveable piston valve rod, a first piston valve outlet in fluid communication with a first cavity of the retractable fluid applicator wand, and a second piston valve outlet in fluid communication with a second cavity of the retractable fluid applicator wand.

7. The hygiene washing system of claim 6 wherein the outer shell has a cavity between an inner shell and outer shell operable to slidably receive the tank column assembly.

8. The hygiene washing system of claim 7 wherein a mixing tank outlet connector engages an autofill membrane air cavity.

9. The hygiene washing system of claim 6 further comprising a mixing core spring positioned around the mixing needle, wherein the mixing needle extends from a needle base positioned on an interior surface of the tank lower assembly.

10. The hygiene washing system of claim 9 wherein the needle base is coupled to the tank lower assembly.

11. The hygiene washing system of claim 1 wherein a mixing core inner shell defines a mixing core chamber operable to receive a mixing pod.

12. The hygiene washing system of claim 1 further comprising a push-push mechanism.

13. The hygiene washing system of claim 1 further comprising an autofill hook that snaps into an autofill hook grappling notch.

14. The hygiene washing system of claim 13 further comprising a vent hole.

15. The hygiene washing system of claim 1 wherein the base further comprises aa base housing having a length and a width, wherein the width decreases from a first end to a second end along the width.

16. The hygiene washing system of claim 15 wherein the base is configured to receive the retractable fluid applicator wand within a recess on a front surface of the base.

17. The hygiene washing system of claim 15 wherein the base has a reel assembly operable to wrap a fluid carrying tube engaging the retractable fluid applicator wand at a first end and the base at a second end around a pulley assembly.

18. The hygiene washing system of claim 17 wherein the pulley assembly has a pulley mount engaging a plurality of pulleys of differing diameters, wherein each of the plurality of pulleys has a groove operable to engage the fluid carrying tube.

19. The hygiene washing system of claim 18 the pulley assembly further comprises a retractor in communication with an elongated retractor cable.

20.-75. (canceled)

76. A fluid applicator comprising:
a wand having a fluid applicator wand body with an elongated central housing aperture with a wand actuator at a first end of the elongated central housing aperture, and a pair of adjacent fluid delivery apertures comprising a first fluid delivery aperture and a second fluid delivery aperture.

77.-81. (canceled)

82. A mixing tank apparatus for a hygiene washing system comprising:
a base; and
a mixing tank comprising an outer shell, a tank column assembly positioned within the outer shell, a mixing core which engages the tank column assembly, a lower tank assembly with a mixing needle, and a piston valve.

83.-109. (canceled)

107.

110. A pod comprising:
an encapsulation sheath having a flattened spherical shape; and
a concentrated solution comprising lactic acid, mandelic acid, sodium diacetate, potassium sorbate, and polysorbate 20 wherein the concentrated solution achieves a pH balance after a dilution of from 1:500 to 1:700 dilution in water and a pH between 3.8 and 5.5.

111.-131. (canceled)
